(19) United States
(12) Patent Application Publication
(10) Pub. No.: US 2015/0242381 A1
(43) Pub. Date: Aug. 27, 2015

(54) DATA TRANSITION PROCESSING METHOD AND ELECTRONIC DEVICE SUPPORTING THE SAME

(71) Applicant: Samsung Electronics Co., Ltd., Gyeonggi-do (KR)

(72) Inventors: Sung Jo OH, Gyeonggi-do (KR); Sung Kwon JUNG, Gyeonggi-do (KR); Young Kyoo KIM, Seoul (KR)

(21) Appl. No.: 14/628,649

(22) Filed: Feb. 23, 2015

(30) Foreign Application Priority Data
Feb. 23, 2014 (KR) 10-2014-0021014

(51) Int. Cl. G06F 17/22; G06F 17/21

(52) U.S. Cl. CPC G06F 17/2258; G06F 17/212; G06F 17/2247

(57) ABSTRACT

An electronic device and method for data conversion processing are disclosed. The electronic device includes a communication interface configured to communicatively couple with an external server, and a control module. The control module may implement the method, which includes receiving a request to display content that is at least one of unoptimized or incompatible with data processing functionality of the electronic device, in response to the request, transmitting to the external server the content and at least one of a desired data type and a configuration setting of the electronic device, receiving from the external server a converted content optimized or compatible with the data processing functionality, converted by a renderer of the external server utilizing the at least one of the desired type and the configuration setting, and displaying the converted content on the display.

### CROSS-REFERENCE TO RELATED APPLICATION

This application claims priority from Korean patent application No. 10-2014-0021014 filed Feb. 23, 2014, the disclosure of which is hereby incorporated in its entirety by reference.

### TECHNICAL FIELD

This application relates to data conversion processing.

### BACKGROUND

With the development of digital technology, various electronic devices for mobile communication and information processing, such as mobile communication devices, personal digital assistants (PDAs), electronic organizers, smartphones and tablet PCs, have recently been released on the market. Such electronic devices support a function of transmitting or sharing data between devices.

### SUMMARY

At least a portion of specific data (e.g., content) of a conventional electronic device may be processed abnormally, may be incompatible with a supported function of the electronic device, or may otherwise be unable to be processed. Furthermore, the electronic device may output data that cannot be processed to identify a data error or loss.

Various embodiments are associated with providing a data conversion processing method for converting data according to a function support state of an electronic device so that the data is read, output or stored normally, and an electronic device supporting the same.

Various embodiments are associated with providing a data conversion processing method in which control authority is shared between various communicable electronic devices so that output or storage of information is more easily and flexibly performed in a device designated by a user, and an electronic device supporting the same.

According to an embodiment of the present disclosure, an electronic device includes a communication interface configured to transmit content to a server device upon receiving at least one of requests for output, storage and transmission of the content, and a control module configured to receive the content rendered on the basis of at least one of the type of the content and a setting (or configuration) of the electronic device in the server device, and perform at least one of output, storage and transmission of the received content, wherein the electronic device does not include a renderer for the content or includes a first renderer of a first quality level, wherein the rendered content is rendered by a second renderer of a second quality level of the server device.

According to an embodiment of the present disclosure, a server device includes a server communication module configured to receive content from the outside, and a server control module configured to render the content using a renderer related to the content, and convert the rendered content into content corresponding to a renderer of an electronic device that is to receive the rendered content or a driver of a peripheral device.

According to an embodiment of the present disclosure, a data conversion processing system includes an electronic device including a first renderer that outputs or plays content of a specific quality level at a quality level different from the specific quality level, and a server device configured to output or play the content using a second renderer that outputs or plays the content at the specific quality level, and generate type conversion data that is output through the electronic device with a quality level equal or similar to the specific quality level to provide the type conversion data to the electronic device.

According to an embodiment of the present disclosure, an electronic device includes: a communication interface configured to communicatively couple with an external server; and a control module configured to receive a request to display content that is at least one of unoptimized or incompatible with data processing functionality of the electronic device, in response to the request, transmit to the external server the content and at least one of a desired data type and a configuration setting of the electronic device, receive from the external server a converted content optimized or compatible with the data processing functionality, converted by a renderer of the external server utilizing the at least one of the desired type and the configuration setting, and display the converted content on the display.

According to an embodiment of the present disclosure a method for operating an electronic device, the method comprising receiving a request to display content of a first format that is at least one of unoptimized and incompatible with data processing functionality of the electronic device, in response to the request, transmit to an external server the content and at least one of a desired second format and a configuration setting of the electronic device, receiving from the external server a converted content optimized or compatible with the data processing functionality, converted by a renderer of the external server utilizing the at least one of the desired second format and the configuration setting, and displaying the converted content on the display.

Other aspects of the disclosure will become apparent to those skilled in the art from the following detailed description, which, taken in conjunction with the annexed drawings, discloses various embodiments of the present disclosure.

### BRIEF DESCRIPTION OF THE DRAWINGS

FIG. 1 is a diagram illustrating a data conversion processing system environment according to an example embodiment;

FIG. 2 is a block diagram illustrating a data processing agent of an electronic device according to an example embodiment;

FIG. 3 is a block diagram illustrating a server device according to an example embodiment;

FIG. 4 is a block diagram illustrating an external device according to an example embodiment;

FIG. 5 is a flowchart illustrating a method for operating an electronic device in relation to data conversion processing according to an example embodiment;

FIG. 6 is a flowchart illustrating a server device operating method related to data conversion processing according to an example embodiment;

FIG. 7 is a flowchart illustrating an external device operating method related to data conversion processing according to an example embodiment;

FIG. 8 is a diagram illustrating data conversion processing between an electronic device and a server device according to an example embodiment;

FIG. 9 is a diagram illustrating data conversion processing among an electronic device, a server device and a first external device according to an example embodiment;

FIG. 10 is a diagram illustrating data conversion processing among an electronic device, a server device and a first peripheral device according to an example embodiment;

FIG. 11 is a diagram illustrating data conversion processing among an electronic device, a server device and a second external device according to an example embodiment;

FIG. 12 is a diagram illustrating data conversion processing among an electronic device, a server device, a second external device and a second peripheral device according to an example embodiment;

FIG. 13 is a diagram illustrating data conversion processing among an electronic device, a server device, a first external device and a first peripheral device according to an example embodiment;

FIG. 14 is a diagram illustrating data conversion processing among an electronic device, a server device, a first external device and a third peripheral device according to an example embodiment;

FIG. 15 is a diagram illustrating a screen interface of an electronic device related to data conversion processing according to an example embodiment; and

FIG. 16 is a block diagram illustrating an electronic device according to another example embodiment.

### DETAILED DESCRIPTION

Hereinafter, the present disclosure will be described with reference to the accompanying drawings. The present disclosure may be variously modified and may include various embodiments. However, specific embodiments are exemplarily illustrated in the drawings and detailed descriptions related thereto are provided. However, it should be understood that the present disclosure is not limited to the specific embodiments, but rather includes all modifications and/or equivalents or alternatives which fall within the ambit of the present disclosure. Regarding the drawings, like reference numerals refer to like elements.

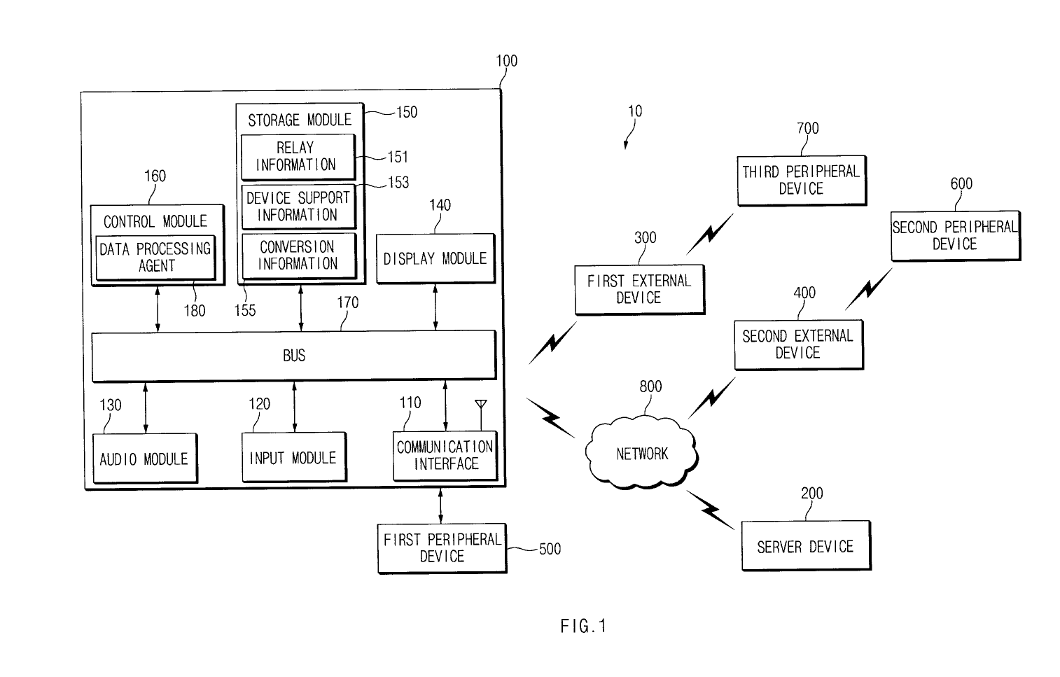

FIG. 1 is a diagram illustrating a data conversion processing system environment according to an example embodiment.

Referring to FIG. 1, a data conversion processing system 10 according to an embodiment may include an electronic device 100, a server device 200 and a network 800, and may further include other electronic devices (e.g., external devices 300 and 400 and peripheral devices 500, 600 and 700). According to various embodiments, the data conversion processing system 10 may further include a first peripheral device 500 connected to the electronic device 100 through a direct communication channel and a first external device 300 connected to the electronic device 100 through a direct communication channel. According to an embodiment, the data conversion processing system 10 may further include a second external device 400 connected to the electronic device 100 via the network 800, a second peripheral device 600 connected to the second external device 400, and a third peripheral device 700 connected to the first external device 300. Here, the electronic device 100 may include at least one of various wearable devices such as a smartphone, a smartwatch or smartglasses.

The data conversion processing system 10 may transmit first data (or content) to the server device 200, wherein the first data is not processed or optimized according to a data processing type of the electronic device 100. This first data may not be able to be processed or utilized optimally because of a limited or incompatible data processing type based on hardware characteristics of the electronic device 100, a limited or incompatible data processing type according to characteristics of software (e.g., at least one renderer for supporting playback or output of specific data), a platform (e.g., Mac OS, MS or Windows OS, iOS, Android OS, Tizen OS, etc.) or a driver of the electronic device 100, or a data processing type that is not supported by hardware or software (e.g., a specific renderer). The electronic device 100 may receive, from the server device 200, type conversion data (or rendered data, data converted on the basis of rendered content, or second data) optimized for the electronic device 100.

The first data may be data that may be unable to be processed normally in the electronic device 100 or may suffer data loss or an error while being processed. According to an embodiment, the first data may be data optimized for hardware characteristics or software characteristics of the first external device 300, the second external device 400 and the like, and may thus suffer an error in conversion of at least a part of the data while processed by the electronic device 100, may not be fit to a display module scale of the electronic device 100, or may undergo a change in a content arrangement while being displayed. According to an embodiment, the first data may be data based on characteristics of hardware or software for which an optimized version is different from that of hardware or software of the electronic device 100, such as, for example, characteristics of higher-version or lower-version hardware or software. Alternatively, the first data may be compatible with hardware or software characteristics not supported by the electronic device 100.

According to various embodiments, the electronic device 100 may not include a renderer for outputting the first data or may include a renderer of a first quality level. Accordingly, a quality of playing or outputting the first data by the electronic device 100 using the renderer of the first quality level may be different from that of playing or outputting the first data using a renderer of a second quality level provided in the server device 200. For example, a quality level of outputting the first data of the electronic device 100 may be lower than that of the first data of an external device.

According to various embodiments, the quality level of outputting or playing the first data by the hardware or software of the electronic device 100 may be relatively lower than that of outputting or playing the first data by external devices (e.g., a device including a renderer that supports playback of data based on a general or commercial purpose OS, or a renderer of the second quality that is relatively high). Here, the electronic device 100 may be a mobile device having relatively low characteristics of hardware or software, and the external devices may be devices in which personal computer (PC) operating systems or PC-level programs are installed. The second quality level may be equal or similar to a quality level of a renderer operated by a general purpose OS. For example, the general purpose OS may be at least one of Windows OS and MAC OS.

An output quality level of data may be classified according to a degree of compatibility or optimization with respect to hardware or software characteristics of each device. The degree of compatibility or optimization may be digitized for each renderer in a specific device. For example, the output quality level of the first data may be represented by a level digitized in relation to the case of outputting the first data by a specific renderer installed in the electronic device 100. Furthermore, the output quality level of the first data may be represented by a level digitized in relation to the case of outputting the first data by the server device 200, the external devices or the peripheral devices.

According to various embodiments, the electronic device 100 may establish a communication channel to another electronic device (e.g., at least one of the external devices and peripheral devices 500 to 700), and may receive, from the other electronic device, the first data not matched to the data processing type of the electronic device 100. According to various embodiments, the electronic device 100 may transmit the first data to the server device 200, and may receive, from the server device 200, first type conversion data matched to the data processing type of another electronic device (e.g., a specific external device or a specific peripheral device) that is to receive converted data. The electronic device 100 may transmit the received first type conversion data to the other electronic device.

According to various embodiments, the electronic device 100 may include a communication interface for receiving type conversion data, at least a part of which has been converted so as to be efficiently matched to the data processing type of the electronic device 100 or another electronic device. The electronic device 100 may include a control module (e.g., a “controller” or a “processor”) for controlling at least one of outputting, storing and transmitting of the received type conversion data.

A “source rendering representation rate value” may be used for data type (or data format) matching for obtaining an output approximate to a source most efficiently according to characteristics of software/hardware included in the electronic device. The “source rendering representation rate value” may indicate a degree of proximity (or Similarity, or Quality) of rendered content to a source of the same content, the content being output by each renderer (e.g., a renderer such as an output module 20 of the electronic device, an output module of the external device or an output module of the peripheral device). Or, the “source rendering representation rate value” may be a similarity ratio of preconversion data and postconversion data. A “pre-defined source rendering representation rate value” or a “source rendering representation rate value in real-time calculated” may be used as the “source rendering representation rate value”. The source rendering representation rate value may be pre-defined, or calculated in real-time. The pre-defined source rendering representation value may be obtained and/or received remotely from another terminal, from a content creation program, or from local storage in the electronic device or the peripheral device. The source rendering representation rate value calculated in real-time may be generated in real-time based on characteristics of elements included in a renderer, and a determination as to whether those characteristics indicate a desired degree of proximity between a rendering result of the renderer and a source of the content. The criterion for determining the desired output representation rate relative to a source may be obtained remotely, from a content creation program, or may be stored locally in the electronic device or the peripheral device. Furthermore, a user, the renderer or the server device may select at least one of a renderer representation quality and a renderer data processing rate with respect to the renderer's rendering function according to a quality value to ensure that a representative quality of the renderer output is appropriately approximate to a quality of the source data, as rendered in the server device. A user may thus select a recommendation for achieving an optimal rendering value in consideration of software/hardware characteristics of a final output unit, or alternatively, the recommendation may be automatically selected by the output software or by a server. Furthermore, according to various embodiments, to efficiently match a rendering value in consideration of the data processing type of the final output device, a rendering environment may be utilized that is most closely approximate to a rendering environment used for creation of the data source. The rendering environment may be selected from various rendering environments in the server device and utilized or activated according to the selection.

According to various embodiments, in the data conversion processing system 10, the electronic device 100 may receive the first data from at least one of the first external device 300 and the second external device 400. The electronic device 100 may transmit the first data to the server device 200 to receive the first type conversion data (e.g., data processed without an error on the basis of the data processing type of the electronic device 100, or data compatible with the hardware or software characteristics of the electronic device 100 to be processed normally) able to be processed normally (e.g., processing without an error or loss, processing compatible with or optimized for the size or resolution of a display module 140 of the electronic device 100, or storage processing optimized for a storage module or memory 150 of the electronic device 100) on the basis of the data processing type of the electronic device 100 and may output or store the first type conversion data.

According to various embodiments, in the data conversion processing system 10, the electronic device 100 may request conversion of the first data into a second type which is able to be processed normally in at least one of the first to third peripheral devices 500 to 700, while transmitting the first data to the server device 200. Upon receiving second type conversion data from the server device 200, the electronic device 100 may transmit the second type conversion data to at least one of the first to third peripheral devices 500 to 700. The at least one of the first to third peripheral devices 500 to 700 which has received the second type conversion data may print, display, sound, project or otherwise output the second type conversion data to a display module or an audio module, or may store the second type conversion data according to device characteristics. Here, the second type conversion data may be at least one of, for example, data processed without an error or loss in the first to third peripheral devices 500 to 700, data compatible with or optimized for characteristics of display modules or storage modules of the first to third peripheral devices 500 to 700 to be processed, or data compatible with or optimized for output characteristics of the first to third peripheral devices 500 to 700 to be processed.

According to various embodiments, in the data conversion processing system 10, the electronic device 100 may transfer the first data (data provided by at least one of the first external device 300 and second external devices 400) to the server device 200 to request second type conversion (conversion to data able to be processed normally in at least one of the second peripheral device 600 and the third peripheral device 700 connected to the first external device 300 and second external devices 400). Upon receiving the second type conversion data from the server device 200, the electronic device 100 may transmit the second type conversion data to at least one of the second peripheral device 600 and the third peripheral device 700 via at least one of the first external device 300 and second external devices 400. The second peripheral device 600 and the third peripheral device 700 may print the received second type conversion data, may output the received second type conversion data to a display module or an audio module, or may store the received second type conversion data.

In the above-mentioned embodiments, the data conversion processing system 10 may support the server device 200 so that the server device 200 receives device information related to the data processing types of the external device 300 and the external device 400 and the peripheral devices 500 to 700, in order to support at least one of first type conversion and second type conversion of the first data. Here, the device information may include at least one of hardware information and software information related to the data processing types of the electronic device 100, the external device 300 and the external device 400 and the peripheral devices 500 to 700.

The first external device 300 may allow establishment of a communication channel to a communication interface 110 of the electronic device 100. According to an embodiment, the first external device 300 may establish the communication channel to the electronic device 100 bypassing the network 800, on the basis of at least one of a wired communication module, a short-range communication module and a direct communication module. The first communication module 210 may establish the communication channel to the electronic device 100 using at least one of, for example, a Wi-Fi direct communication scheme, a Bluetooth communication scheme, a UART communication scheme or a USB communication scheme. According to an embodiment, the first external device 300 may be electrically connected to the third peripheral device 700. For example, the first external device 300 may be connected to the third peripheral device 700 on the basis of at least one of a wireless communication channel or a wired communication channel. According to various embodiments, the first external device 300 may transmit the first data to the electronic device 100, the communication channel to which has been established. According to various embodiments, the first external device 300 may receive the second type conversion data from the electronic device 100. The first external device 300 may transmit the received second type conversion data to the third peripheral device 700.

The second external device 400 may be connected to the electronic device 100 through the network 800. According to an embodiment, the second external device 400 may establish a communication channel to the electronic device 100 using a cellular communication module or a Wi-Fi communication module through a base station or an access point (AP) included in the network 800. The second external device 400 may be connected to the second peripheral device 600 on the basis of a wired communication channel or a wireless communication channel. According to various embodiments, the second external device 400 may establish a communication channel to the second peripheral device 600 on the basis of the network 800. According to various embodiments, the second external device 400 may transmit the first data to the electronic device 100 through the network 800. According to various embodiments, the second external device 400 may receive the second type conversion data from the electronic device 100 through the network 800.

The second external device 400 may transmit the received second type conversion data to the second peripheral device 600. In this operation, the second external device 400 may transmit the second type conversion data to the second peripheral device 600 on the basis of a wired/wireless communication channel directly connected thereto. Alternatively, the second external device 400 may transmit the second type conversion data to the second peripheral device 600 through the network 800.

The first peripheral device 500 may establish a communication channel to the electronic device 100. For example, the first peripheral device 500 may establish a short-range communication channel or a direct communication channel to the electronic device 100. The first peripheral device 500 may receive the second type conversion data from the electronic device 100. The first peripheral device 500 may output or store the second type conversion data. According to an embodiment, the first peripheral device 500 may print the second type conversion data. According to an embodiment, the first peripheral device 500 may output the second type conversion data to at least one of a display module and an audio module included in the first peripheral device 500.

According to various embodiments, the first peripheral device 500 may establish a communication channel to the electronic device 100 through the network 800. In relation to this operation, the first peripheral device 500 may include a communication module for establishing a communication channel based on the network 800, such as a cellular module, an Ethernet communication module or a Wi-Fi communication module. According to various embodiments, the first peripheral device 500 may transmit second data optimized therefor to the electronic device 100. Here, the second data may be data compatible with or optimized for hardware and software characteristics of the first peripheral device 500. Alternatively, the second data may be data generated or converted so as to be compatible with a specific driver of the first peripheral device 500.

The second peripheral device 600 may establish a communication channel to the second external device 400 that establishes a communication channel to the electronic device 100 through the network 800. For example, the second peripheral device 600 may be connected to the second external device 400 on the basis of a wired device such as a cable. The second peripheral device 600 may be connected to the second external device 400 on the basis of a short-range communication module. The second peripheral device 600 may receive the second type conversion data from the second external device 400.

The second peripheral device 600 may output or store the received second type conversion data according to device characteristics. For example, the second peripheral device 600 may print the second type conversion data. The second peripheral device 600 may output the second type conversion data through at least one of a display module or an audio module. Alternatively, the second peripheral device 600 may store the second type conversion data.

According to various embodiments, the second peripheral device 600 may establish a communication channel to the second external device 400 through the network 800. In relation to this operation, the second peripheral device 600 may establish, for example, a mobile communication network channel based on a cellular module or a Wi-Fi communication module or a wired network channel based on an Ethernet communication module. The second peripheral device 600 may transmit the second data optimized therefor to at least one of the second external device 400 and the electronic device 100.

The third peripheral device 700 may establish a communication channel to the first external device 300 connected to the electronic device 100 through a direct communication channel. The third peripheral device 700 may be connected to the first external device 300 on the basis of, for example, a wired communication channel or a direct communication channel. The third peripheral device 700 may receive the second type conversion data through the first external device 300. The third peripheral device 700 may output the received second type conversion data (e.g., displaying (or outputting) the second type conversion data on a display module, or outputting the second type conversion data to an audio module or a printer) or may store the second type conversion data. Here, the second type conversion data may be obtained by converting, by the server device 200, data provided from the electronic device 100 or the first external device 300. The third peripheral device 700 may transmit the second data optimized therefor to at least one of the first external device 300 and the electronic device 100. Alternatively, the third peripheral device 700 may transmit the second data to the server device 200. In this operation, the second data may be directly transmitted to the server device 200 if the network 800 is accessible by the third peripheral device 700. Alternatively, the second data may be transmitted to the server device 200 via the first external device 300, the electronic device 100 or the network 800.

The network 800 may support establishment of at least one of a communication channel between the electronic device 100 and the external device 300 and the external device 400, a communication channel between the electronic device 100 and the peripheral devices 500 to 700, a communication channel between the external device 300 and the external device 400 and the peripheral devices 500 to 700 and a communication channel between the electronic device 100 and the server device 200. Furthermore, the network 800 may support establishment of at least one of a communication channel between the external device 300 and the external device 400 and the server device 200 and a communication channel between the peripheral devices 500 to 700 and the server device 200. The network 800 may support transmission of the first data, the second data, the first type conversion data and the second type conversion data. In relation to this operation, the network 800 may be configured to support at least one of mobile communication and wired communication. According to various embodiments, the network 800 may support transmission of driver installation files, editor files and the like between the electronic device 100, the peripheral devices 500 to 700 and the server device 200.

The server device 200 may establish a communication channel to at least one of the electronic device 100, the external device 300 and the external device 400 and the peripheral devices 500 to 700 through the network 800. The server device 200 may convert the first data provided from at least one of the foregoing devices so that the first data is processed normally without an error or loss in a specific device, or the first data becomes compatible with display characteristics or audio output characteristics of the specific device, or the first data is optimized for storage characteristics of the specific device. The server device 200 may transmit, to the specific device, the first type conversion data or the second type conversion data obtained through conversion of data. For example, the server device 200 may transmit, to the electronic device 100, the first type conversion data generated so as to be compatible with the data processing type of the electronic device 100. The server device 200 may transmit, to the peripheral devices 500 to 700, the second type conversion data generated so as to be compatible with the data processing types of the peripheral devices 500 to 700.

According to various embodiments, the server device 200 may generate third type conversion data compatible with the data processing types of the external device 300 and the external device 400. Furthermore, the server device 200 may transmit the generated third type conversion data to the external device 300 and the external device 400. Here, the third type conversion data may be data processed without an error or loss on the basis of the data processing types of the external device 300 and the external device 400 according to hardware and software characteristics thereof, data compatible with or optimized for characteristics of display modules or storage modules of the external device 300 and the external device 400 to be processed, or data compatible with or optimized for output characteristics of the external device 300 and the external device 400.

According to various embodiments, the server device 200 may perform type conversion of the second data compatible with the data processing types of the peripheral devices 500 to 700 and third data compatible with the data processing type of the electronic device 100. Furthermore, the server device 200 may transmit type-converted data to a specific device.

The electronic device 100 may differ from the external device 300 and the external device 400 and the peripheral devices 500 to 700 with respect to at least one of hardware characteristics and software characteristics. As illustrated in FIG. 1, the electronic device 100 may include the communication interface 110, an input module 120, an audio module 130, the display module 140, the storage module 150, a control module 160 and a bus 170.

According to various embodiments, the above-mentioned electronic device 100 may establish a communication channel to another electronic device (e.g., at least one of the external devices and the peripheral devices 500 to 700), and may receive, from the other electronic device, the first data not matched to the data processing type of the electronic device 100. According to various embodiments, the electronic device 100 may transmit the first data to the server device 200, and may receive, from the server device 200, the first type conversion data matched to the data processing type of another electronic device (e.g., a specific external device or a specific peripheral device) that is to receive converted data. The electronic device 100 may transmit the received first type conversion data to the other electronic device.

The communication interface 110 may establish a communication channel to the network 800. According to an embodiment, the communication interface 110 may establish the communication channel to the network 800 according to a communication scheme based on, for example, 3G/4G communication technology. According to an embodiment, the communication interface 110 may establish a communication channel according to a Wi-Fi communication scheme. The communication interface 110 may establish a communication channel to the server device 200 through the network 800. In relation to this operation, the electronic device 100 may access the server device 200 using pre-stored or input address information. Here, the address information that is information on an IP address and the like may include identification information of the server device 200 registered in the network 800.

According to an embodiment, the communication interface 110 may establish a communication channel to at least one of the external device 300 and the external device 400. For example, the communication interface 110 may establish a short-range communication channel or a direct communication channel to the first external device 300. The communication interface 110 may establish a communication channel to the second external device 400 based on the network 800. According to various embodiments, the communication interface 110 may establish a short-range communication channel or a direct communication channel to at least one of the peripheral devices 500 to 700 or may establish a communication channel thereto based on the network 800.

The communication interface 110 may transmit device information related to the data processing type of the electronic device 100 and device information related to the data processing types of the peripheral devices 500 to 700 in response to control by the control module 160. The communication interface 110 may transmit the first data to the server device 200 in response to the control by the control module 160. According to various embodiments, the communication interface 110 may receive the second data from the peripheral devices 500 to 700 or the external device 300 and the external device 400 and may transmit the second data to the server device 200. The communication interface 110 may receive the first type conversion data and the second type conversion data from the server device 200.

The input module 120 may generate an input signal related to operation of the electronic device 100. For example, the input module 120 may include a physical key button (e.g., a home key, a side key or a power key), a jog key, a keypad and the like. The input module 120 may include a virtual keypad output to the display module 140 as an input device. The input module 120 may generate an input signal related to execution of a specific application (e.g., a web access function, a file view function or a file edit function). According to an embodiment, the input module 120 may generate, in response to control by a user, an input signal for requesting a search for data stored in the storage module 150, an input signal for selecting the first data from retrieved data, a request signal for accessing the server device 200, an input signal for requesting type conversion of the first data, and an input signal for requesting outputting, storing or transferring of received first type conversion data. Here, the input module 120 may generate, in response to the control by the user, an input signal for requesting the first type conversion of the first data or an input signal for requesting the second type conversion of the first data. The foregoing input signals may be provided to the control module 160 so as to be used as function performance events corresponding to the input signals.

The audio module 130 may support a function related to audio data output and audio data collection of the electronic device 100. In relation to this operation, the audio module 130 may include a speaker for outputting audio data and at least one microphone for supporting the audio data collection. In the case where the first type conversion data includes audio data, the audio module 130 may be automatically enabled upon receiving the first type conversion data. According to an embodiment, the audio module 130 may output audio data for providing a guide for a request for type conversion of the first data, audio data for providing a guide for reception of the first type conversion data or the second type conversion data, and audio data for providing a guide for relaying the second type conversion data. Outputting of the audio data may be skipped according to a setting.

The display module 140 may provide at least one screen interface (or a user interface) related to operation of the electronic device 100. For example, the display module 140 may output a lock screen, a turn-off screen of a sleep mode, a standby screen or a menu screen. According to an embodiment, the display module 140 may display a first data search screen, a screen related to a request for type conversion of the first data, a screen related to reception of type-converted data, or a screen related to output of the type-converted data. The display module 140 may display a screen related to storage of the type-converted data or a screen relate to transfer of the type-converted data. According to an embodiment, the display module 140 may output a screen related to access to the server device 200, a screen corresponding to a state in which a communication channel to the external device 300 and the external device 400 is established, or a screen corresponding to a state in which a communication channel to the peripheral devices 500 to 700 is established.

According to an embodiment, when outputting the first data, the display module 140 may output a screen on which at least a part of the first data has an error. Alternatively, the display module 140 may output a screen on which at least a part of the first data is lost. Alternatively, the display module 140 may output a screen corresponding to a part of the first data. According to an embodiment, the display module 140 may output a screen related to the first type conversion data obtained by type-converting the first data. In this operation, the display module 140 may output a screen compatible with display characteristics (e.g., a scale, resolution or content arrangement position) according to the first type conversion data. Alternatively, the display module 140 may output a screen compensated for the error or loss by virtue of output of the first type conversion data. Alternatively, the display module 140 may output a screen corresponding to the entirety of the first type conversion data.

The storage module 150 may store information related to operation of the electronic device 100, for example, an operating system and application data for performing a specific function. The storage module 150 may store information related to data conversion processing. For example, the storage module 150 may include relay information 151, device support information 153 and conversion information 155.

The relay information 151 may be conversion data to be transferred to at least one of the external device 300 and the external device 400 and the peripheral devices 500 to 700. According to an embodiment, the storage module 150 may store, as the relay information 151, the second type conversion data provided from the server device 200 and identification information of the peripheral devices 500 to 700 that are to receive the second type conversion data (e.g., address information or communication channel information of the peripheral devices). The storage module 150 may store, as the relay information 151, the third type conversion data provided from the server device 200 and identification information of the external device 300 and the external device 400 that are to receive the third type conversion data (e.g., address information or communication channel information of the external devices). The storage module 150 may store the relay information 151 for a predetermined period of time (e.g., several minutes to several tens of minutes, or several hours to several tens of hours), and may automatically remove the relay information in response to control by the control module 160 after elapse of the predetermined period of time.

The device support information 153 may include device information (e.g., at least one of hardware information and software information) related to the data processing type of the electronic device 100. For example, the device support information 153 may include hardware information including CPU information and graphic card information of the electronic device 100, size and resolution information of the display module 140 and audio channel information of the audio module 130. The device support information 153 may include software information including the type and version information of a file viewer of the electronic device 100, the type and version information of a file editor, the type and version information of an audio playback program, the type and version information of an image playback program, and the type and version information of a driver related to hardware support or platform support of the electronic device 100. According to an embodiment, the device support information 153 may include at least one of pieces of information on data types able to be processed in the electronic device 100 on the basis of the above-mentioned device information, for example, information on data types able to be played in the electronic device 100 and information on data types able to be stored in the electronic device 100. The data type information may be changed according to installation or update of a program or replacement of hardware of the electronic device 100. The data type information may be provided to the server device 200.

According to an embodiment, the device support information 153 may include data support information about data supportable by the server device 200. The data support information may include information on data types able to be processed in the server device 200. The data support information may be received from the server device 200 to be stored. The data support information may be changed according to installation or update of a program or replacement of hardware of the server device 200. When data support characteristics of the server device 200 are changed, the data support information in the device support information 153 may be updated by update information provided from the server device 200.

According to various embodiments, the device support information 153 may include device information (e.g., at least one of hardware information and software information) related to the data processing types of the external device 300 and the external device 400 and the peripheral devices 500 to 700 connected to the electronic device 100 and the information on data types able to be processed in the external device 300 and the external device 400 and the peripheral devices 500 to 700. According to an embodiment, the device support information 153 may include at least one of the data support information and the device information related to the data processing type of a peripheral device or an external device that is to receive the second type conversion data or the third type conversion data included in the relay information 151. The device information and the data support information of the peripheral device or the external device may be provided to the server device 200.

The conversion information 155 may be the first type conversion data received from the server device 200. The conversion information 155 may include information obtained by mapping the first type conversion data to the first data. According to various embodiments, the conversion information 155 may include the first type conversion data alone. In relation to this operation, the conversion information 155 may include the first data before conversion thereof, and may store the first type conversion data replacing the first data after the conversion. The first type conversion data included in the conversion information 155 may be transmitted in response to a request from another electronic device.

The bus 170 may support data transfer between modules of the electronic device 100. For example, the bus 170 may transfer, to the communication interface 110, the first data stored in the storage module 150 or received through the communication interface 110 according to control by the control module 160. The bus 170 may transfer the received first type conversion data to at least one of the display module 140 and the audio module 130. According to an embodiment, the bus 170 may transfer the second type conversion data to the communication interface 110.

The control module 160 may perform transmission and processing of data related to operation of the electronic device 100. The control module 160 may perform transmission and processing of control signals related to operation of the electronic device 100. The control module 160 may include a data processing agent 180 related to data conversion processing. The data processing agent 180 may control output, storage or transfer of the first data (e.g., data provided from external devices) of the electronic device 100. The data processing agent 180 may control output, storage or transfer of the second data (e.g., data provided from peripheral devices).

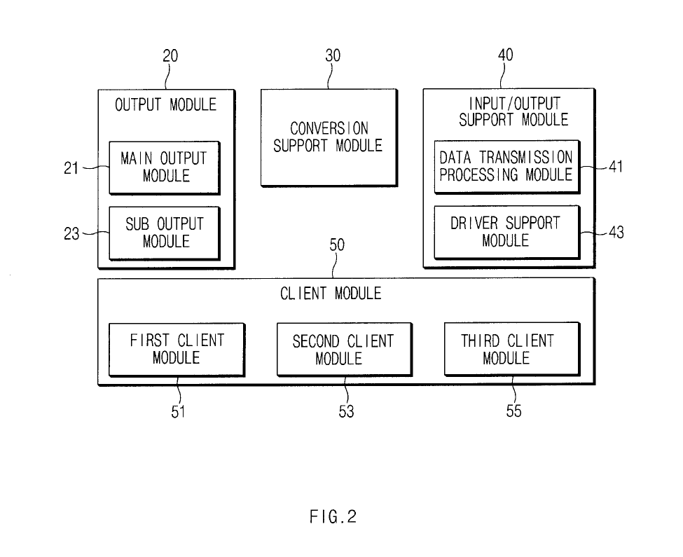

FIG. 2 is a block diagram illustrating a data processing agent of an electronic device according to an example embodiment.

Referring to FIG. 2, the data processing agent 180 may include an output module 20, a conversion support module 30, an input/output support module 40 and a client module 50.

The output module 20 may support browsing of data of the electronic device 100. According to an embodiment, the output module 20 may perform a control operation so that a specific type of a document, for example, a document with an extension of .pdf, .hwp, .xml or .txt, etc. is output to the display module 140. The output module 20 may process each supported data type according to the compatible viewer program for each data type installed in the electronic device 100. For example, the output module 20 may perform a control operation so that data compatible with the processing type of the electronic device 100 is played back or otherwise output to the display module 140. The output module 20 may transmit a request to the conversion support module 30 so that data incompatible with the data processing type of the electronic device 100 is transmitted to the server device 200. Type conversion data provided from the server device 200 may include, for example, a sub-function executable by the electronic device 100. The sub-function may be determined or identified according to the type of the first type conversion data. The sub-function may include, for example, rewind, fast-forward, playback, pause, rotation and any other additional extended function (e.g., go-to-page) executable during a playback process of the data. The output module 20 may provide a user interface or UI for the sub-function, and may also provide a program for activating or implementing performance of the sub-function.

The output module 20 may further include a main output module 21 and a sub output module 23.

The main output module 21 may transfer, to the conversion support module 30, the first data incompatible with the data processing type of the electronic device 100. The main output module 21 may execute a control operation so that the first type conversion data is output to the display module 140 when the first type conversion data is received. According to various embodiments, the main output module 21 may update compatible data processing types of the electronic device 100 in response to installation of a specific program, for example, a file viewer or a file editor. The main output module 21 may process the first type conversion data of, for example, an applet type conversion data provided from the server device 200. In relation to this operation, the main output module 21 may support loading of data contents and control of data browsing or navigation (e.g., zooming, panning, hide or show).

According to an embodiment, the main output module 21 may transmit the first data having a specific type (e.g., a Microsoft-based software group such as data types related to Microsoft Word, Excel, PowerPoint, OneNote, Access, Publisher, Project, Visio, etc.; an Adobe-based software group, a programming software viewer group, a project management software group, etc.) to the server device 200, and may receive and process the first type conversion data obtained by converting the first data to a type of data capable of processing within the electronic device 100. In this operation, the main output module 21 may support playback of data of a type with a relative low processing load among data processing types supportable by the electronic device 100. Alternatively, the main output module 21 may support playback of data of a specific type according to hardware characteristics (e.g., a data processing rate) of the electronic device 100. The main output module 21 may check information on the data processing type of the server device 200 with respect to data to be played. In relation to this operation, the main output module 21 may check data processing type information of the server device 200 in the device support information 153. If specific data is not matched to the data processing type information of the server device 200, the main output module 21 may transfer information on this fact to the conversion support module 30.

According to various embodiments, the main output module 21 may perform a viewer process on complex content data. For example, the server device 200 may perform image extraction and packaging for each layer with respect to complex content including a plurality of layers so as to generate the first type conversion data, and may provide the generated first type conversion data. The main output module 21 may perform a control operation so that the packaged first type conversion data is output utilizing a specific viewer, for example, a web browser. In this operation, the main output module 21 may support a user input processing function based on a web browser. The main output module 21 may play back or output the first type conversion data obtained by converting the first data so that the first data is output at the second quality level. The first type conversion data may have a format identical to or different from that of the first data.

The sub output module 23 may be incorporated as a part of the main output module 21 or may be provided as an independent element. The sub output module 23 may be enabled in the case where the electronic device 100 is unable to convert a type on the basis of the server device 200. When a first data playback request is made, the sub output module 23 may output data on the basis of the data processing type supportable by the electronic device 100. For example, the sub output module 23 may perform playback of the first data on the basis of programs (e.g., MS Office or text, PDF, HTML or image supporting programs) pre-installed in the electronic device 100. Alternatively, the sub output module 23 may provide a guide for another type of a local viewer pre-installed in the electronic device 100 so as to support browsing of specific data. The sub output module 23 may include a renderer for playing or outputting the first data at the first quality level.

The conversion support module 30 may request the server device 200 to convert data of the electronic device 100, and may receive type conversion data from the server device 200. The conversion support module 30 may control the communication interface 110 in relation to transmission and reception of data. According to an embodiment, after a request for playback of specific data is made, the conversion support module 30 may receive a data conversion request from the output module 20. The conversion support module 30 may transmit, to the server device 200, the first data requested by the output module 20. The conversion support module 30 may automatically discover the server device 200 on the basis of pre-stored address information of the server device 200, and then may transmit the first data to the server device 200. In this operation, the conversion support module 30 may check the type of the first data, and may determine whether the first data is able to be processed in the server device 200 on the basis of pre-stored data processing type information of the server device 200. If the server device 200 does not support conversion of the first data, the conversion support module 30 may perform a control operation so that an alarm on this fact is output.

According to various embodiments, if the server device does not support conversion of the first data, the conversion support module 30 may check information on applications capable of playing the first data, and may provide the application information to the server device 200. The server device 200 may install a program corresponding to the application information provided from the conversion support module 30, and may perform conversion processing on the received first data.

According to an embodiment, the conversion support module 30 may transmit data conversion request information to the server device 200. In this operation, the conversion support module 30 may select one of data processing types supportable by the electronic device 100 according to a user input, and then may add conversion type selection information to the data conversion request information to transmit the data conversion request information. The conversion support module 30 may support output of a screen for allowing selection of a data processing type. For example, the conversion support module 30 may provide items such as a PDF document, a text document and an image document supportable by the electronic device 100, and may add an item selected by the user (e.g., a PDF document) to the data conversion request information to transmit the data conversion request information to the server device 200.

The input/output support module 40 may perform transmission of the first type conversion data or the second type conversion data to another electronic device. In relation to this operation, the input/output support module 40 may include a data transmission processing module 41 and a driver support module 43.

The data transmission processing module 41 may collect information on another electronic device (e.g., at least one of the external device 300 and the external device 400 or the peripheral devices 500 to 700 of FIG. 1) connected to the electronic device 100. According to an embodiment, the data transmission processing module 41 may discover another electronic device using various discovering protocols (e.g., SNMP or simple network management protocol, mDNS or multicast domain name system, IPP or Internet printing protocol and Paw9100). In this operation, the data transmission processing module 41 may perform a scanning operation (e.g., Wi-Fi scanning, Bluetooth scanning, Ethernet scanning, NFC or near field communication, scanning and USB connection check) to collect information on other electronic devices (e.g., an electronic device directly connected to the electronic device 100 or indirectly connected thereto via another electronic device) capable of transmitting type conversion data. Once the information on other electronic devices is collected, the data transmission processing module 41 may output the information on other electronic devices to the display module 140. If a specific another electronic device is selected by an input event, the data transmission processing module 41 may collect identification information and device information of the selected other electronic device. The data transmission processing module 41 may provide the device information of the other electronic device to the conversion support module 30 so as to support transmission of the device information to the server device 200 when data type conversion is requested.

Once the conversion support module 30 receives the first type conversion data (e.g., data converted to be matched to the data processing type of the other electronic device that has provided the identification information and the device information) from the server device 200, the data transmission processing module 41 may transmit the type conversion data to the other electronic device on the basis of the identification information of the other electronic device. According to various embodiments, the data transmission processing module 41 may collect identification information and device information of a printer connected to the electronic device 100, and may transfer the device information of the printer to the conversion support module 30. Upon receiving type conversion data (e.g., printer description language or PDL type data) obtained through conversion based on the device information of the printer, the data transmission processing module 41 may transmit the type conversion data to the printer.

According to various embodiments, the data transmission processing module 41 may collect device information and identification information of a memory device directly connected to the electronic device 100 or indirectly connected thereto (via another electronic device). The data transmission processing module 41 may transfer the device information of the memory device to the conversion support module 30 so that the device information of the memory device is provided to the server device 200. Upon receiving type conversion data obtained through conversion based on the device information of the memory device from the server device 200, the data transmission processing module 41 may transmit the type conversion data to the memory device.

The driver support module 43 may collect driver information of another electronic device. The driver support module 43 may provide support so that the collected driver information is provided to the server device 200 together with the device information of the other electronic device.

The client module 50 may support communication channel establishment and data transmission/reception of the output module 20, the conversion support module 30 and the input/output support module 40. The module 50 may include a first client 51, a second client 53 and a third client 55.

The first client 51 may support communication with the server device 200 through the network 800. The first client 51 may establish a communication channel to the server device 200 when an event of requesting access to the server device 200 occurs. For example, the first client 51 may be a web client. The first client 51 may perform web-based access to the server device 200. The first client 51 may support installation of the third client 55. The first client 51 may collect detailed information (e.g., device identification information such as name information or nickname information of the external device 300 and the external device 400 and the peripheral devices 500 to 700 and device information related to the data processing types supported by the devices) of another electronic device (e.g., at least one of the external device 300 and the external device 400 and the peripheral devices 500 to 700 of FIG. 1) registered in the server device 200 to output the detailed information to the display module 140. The first client 51 may support data transmission/reception related to addition of nicknames of other electronic devices registered in the server device 200. The first client 51 may provide, to the electronic device 100, a job history of another electronic device (e.g., a history on storage, printing or transfer of data by a certain device) recorded in the server device 200. The first client 51 may support device information and identification information transmission of the conversion support module 30.

The second client 53 may communicate with the server device 200 on the basis of a communication channel different from that of the first client 51. For example, in the case where the first client 51 establishes a communication channel to the server device 200 on the basis of a Wi-Fi network, the second client 53 may establish a communication channel to the server device 200 on the basis of a mobile network. For example, the second client 53 may be a mobile device client. The second client 53 may establish a communication channel to at least one of the peripheral devices 500 to 700. The second client 53 may support information collection and type conversion data transmission of the input/output support module 40.

The third client 55 may support communication with a specific external device (e.g., at least one of the external device 300 and the external device 400 of FIG. 1). The third client 55 may support reception of the first data from the specific external device. The first data received by the third client 55 may be stored in the storage module 150 according to control by the control module 160 or may be output to the display module 140 according to operation of the output module 20. In this operation, if an error or loss occurs on the first data since the first data includes a code or information not matched to the data processing type of the electronic device 100, the third client 55 may request type conversion processing from the conversion support module 30 in response to a request of the output module 20. According to various embodiments, the third client 55 may support data transmission/reception utilized for transferring type conversion data to a specific peripheral device (e.g., at least one of the peripheral devices 500 to 700 of FIG. 1) connected to the specific external device (e.g., at least one of the external device 300 and the external device 400 of FIG. 1).

According to various embodiments, the electronic device 100 may include a communication interface for receiving type conversion data obtained by converting data of which at least a part is not matched to the data processing type of the electronic device 100 or another electronic device (e.g., at least one of the external device 300 and the external device 400 or at least one of the peripheral devices 500 to 700) so that the data is matched to the data processing type, and a control module for controlling at least one of output, storage and transmission of the received type conversion data.

According to various embodiments, the control module may perform a control operation so that device support information related to the data processing type of the electronic device is transmitted to the server device that generates the type conversion data.

According to various embodiments, the control module may control output of the type conversion data using a function different from a function for outputting the data.

According to various embodiments, the control module may perform a control operation so that device support information related to the data processing type of the other electronic device is transmitted to the server device that generates the type conversion data.

According to various embodiments, the control module may perform a control operation so that type conversion data obtained through conversion based on the data processing type of the other electronic device is transmitted to the other electronic device once the type conversion data is received.

According to various embodiments, if the data corresponding to the data processing type of the other electronic device is received from the other electronic device, the control module may transmit the data to the server device that generates the type conversion data.

According to various embodiments, the control module may transmit, to the server device that generates the type conversion data, data corresponding to the data processing type of the other electronic device pre-stored in response to the occurrence of an input event.

According to various embodiments, the control module may remove the pre-stored data and may store the type conversion data when the type conversion data is received.

According to various embodiments, the electronic device may further include a storage module for storing information on the data processing type of the server device that generates the type conversion data, and the control module may determine whether to transmit the data on the basis of information on a data processing state of the server device.

According to various embodiments, the control module may update the information on the data processing type of the server device in response to at least one of program installation, program update and hardware replacement of the server device.

According to various embodiments, an electronic device according to an embodiment includes a portable electronic device housing, at least one process (e.g., the control module 160) disposed in the housing, and a communication interface disposed in the housing and electrically connected to the processor. The processor processes an operation of transmitting data including content in a first format (e.g., data of a specific data processing type of which at least a part is not matched to the data processing type of the electronic device) or data that represents the content to the outside of the electronic device by the communication interface, an operation of receiving data including the content in a second format (e.g., data matched to the data processing type of the electronic device) from the outside of the electronic device, and an operation of displaying the content in the second format by a display that is included in the electronic device or is connectable to the electronic device wirelessly or by wire, wherein the electronic device is unable to output at least one of objects included in the content in the first format with the same quality as that of a source, but, when the content in the second format is displayed, the at least one of the objects which is unable to be output with the same quality as that of the source is able to be output.

According to various embodiments, the first format may include a web document format.

According to various embodiments, the second format may include at least one of PDF (portable document format), PDL, HTML (hyper-text markup language), XPS (XML-PS or extensible markup language paper specification), an image and an applet.

According to various embodiments, at least one of the objects may include at least one of an image, a picture, a captured scene of a video, and an advertisement.

According to various embodiments, the electronic device may further include a display (e.g., the display module 140) disposed in the housing and electrically connected to the processor.

According to various embodiments, the electronic device may display at least a part of the content in the first format on the display before performing the operation of transmitting the content in the first format to the outside of the electronic device.

According to various embodiments, the electronic device may transmit the content in the first format to the outside of the electronic device in response to at least a part of a user input.

According to various embodiments, the electronic device may transmit the content in the first format to the outside of the electronic device according to determination of the electronic device without receiving the user input.

According to various embodiments, in order to make the determination, the electronic device may determine whether the content in the first format includes an object unable to be displayed by the electronic device.

According to various embodiments, the electronic device may transmit the content in the second format to the outside of the electronic device using the communication module.

According to various embodiments, an electronic device according to an embodiment includes a communication interface that transmits content (e.g., the first data) to a server device upon receiving a request for at least one of output, storage and transmission of the content from a user, and a control module that receives rendered content (e.g., the first type conversion data) obtained by rendering the content on the basis of at least one of the type of the content and the data processing type of the electronic device in the server device and performs at least one of output, storage and transmission of the received content, wherein the electronic device does not include a renderer for the content (e.g., the first data) or includes a renderer, software, a program, a driver or an application of the first quality level (e.g., a renderer for playing the content at a quality level different from an original quality level supported by the content), wherein the rendered content may be rendered by a renderer, software, a program, a driver or an application of the second quality level of the server device (e.g., a renderer for playing the content at a quality level similar or identical to the original quality level supported by the content).

According to various embodiments, the first quality level may be lower than the second quality level.

According to various embodiments, the second quality level may be equal or similar to a quality level of a renderer operated by a general purpose OS (i.e. an operating system).

According to various embodiments, the general purpose OS may be at least one of Windows OS and MAC OS.

According to various embodiments, the rendered content may have a format identical to or different from a previous format.

According to various embodiments, the rendered content may include a sub-function able to be performed in the electronic device.

According to various embodiments, the sub-function may be determined according to the content and may include at least one of rewind, fast-forward, playback, pause, rotation and an additional extension (e.g., go-to-page).

According to various embodiments, the electronic device may include a program for displaying a user interface for the sub-function and commanding performance of the sub-function.

According to various embodiments, the control module may transmit, to the server device, information on a peripheral device to which the content is to be transmitted if the request from the user is for transmission of the content.

According to various embodiments, if the request from the user is for transmission of the content, the rendered content may be rendered by the renderer of the second quality level of the server so as to be converted by a driver corresponding to the peripheral device according to the information on the peripheral device.

According to various embodiments, the driver may correspond to the renderer of the second quality level.

According to various embodiments, if the request from the user is for transmission of the content, the electronic device may transmit the received rendered content without converting the received rendered content by the driver corresponding to the peripheral device.

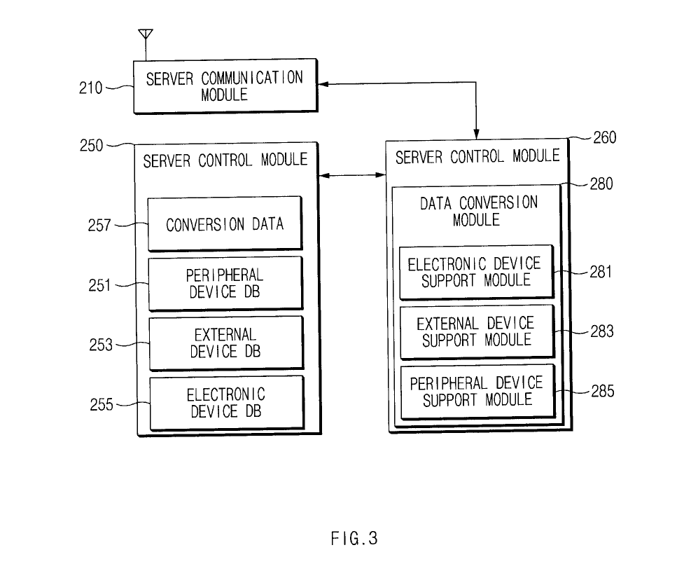

FIG. 3 is a block diagram illustrating a server device according to an embodiment.

Referring to FIG. 3, the server device 200 may include a server communication module 210, a server storage module 250 and a server control module 260. The server device 200 may be a web server device connectable to the electronic device 100 or the external device 300 and the external device 400. Alternatively, the server device 200 may be a cloud server device related to at least one of the electronic device 100 and the external device 300 and the external device 400.

The server communication module 210 may establish communication channels to the electronic device 100 and the external device 300 and the external device 400 through the network 800. The server communication module 210 may receive information related to a request for conversion of the first data from the electronic device 100. The server communication module 210 may provide the received data conversion request information to the server control module 260. According to an embodiment, the server communication module 210 may transmit, to the electronic device 100, the first type conversion data obtained through conversion for compatibility with the data processing type of the electronic device 100. According to an embodiment, the server communication module 210 may transmit, to a specific peripheral device (e.g., at least one of the peripheral devices 500 to 700 of FIG. 1), the second type conversion data obtained through conversion for compatibility with the data processing type of the specific peripheral device. According to various embodiments, the server communication module 210 may transmit, to a specific external device (e.g., at least one of the external device 300 and the external device 400 of FIG. 1), the third type conversion data obtained through conversion for compatibility with the data processing type of the specific external device.

According to various embodiments, the server communication module 210 may receive device information and device identification information from at least one of the electronic device 100 and the external device 300 and the external device 400. Furthermore, the server communication module 210 may receive, from the electronic device 100 and the external device 300 and the external device 400, device information related to the data processing types of the peripheral devices 500 to 700 connected to the electronic device 100 and the external device 300 and the external device 400.

The server storage module 250 may store an operating system and data related to operation of the server device 200. According to an embodiment, the server storage module 250 may include conversion data 257, a peripheral device database 251, an external device database 253 and an electronic device database 255.

The conversion data 257 may be obtained by converting data received from the electronic device 100 and another electronic device (e.g., at least one of the external device 300 and the external device 400 and the peripheral devices 500 to 700 of FIG. 1) so that the data are matched to the data processing type of a specific device. For example, the conversion data 257 may include the first type conversion data obtained through conversion for compatibility with the data processing type of the electronic device 100, the second type conversion data obtained through conversion for compatibility with the data processing types of the peripheral devices 500 to 700, and the third type conversion data obtained through conversion for compatibility with the data processing types of the external device 300 and the external device 400. The conversion data 257 may be stored in the server storage module 250 for a predetermined (or specific) period of time. After elapse of the predetermined period of time, the conversion data 257 may be removed from the server storage module 250 in response to control by the server control module 260.

According to various embodiments, the server storage module 250 may map, for example, the first data of which conversion has been requested by the electronic device 100, the second data of which conversion has been requested by the peripheral devices 500 to 700, and the third data of which conversion has been requested by the external device 300 and the external device 400 to respective conversion data 257 to store the first to third data. The data mapped to the conversion data 257 may be removed when the conversion data 257 is removed from the server storage module 250.

The peripheral device database 251 may include device identification information and device information of the peripheral devices 500 to 700. Here, the device identification information of the peripheral devices 500 to 700 may include information indicating what electronic device or what external device is connected to the peripheral devices. Furthermore, in the case where the peripheral devices 500 to 700 are directly connected to the network 800, the device identification information of the peripheral devices 500 to 700 may include information on an address accessible by the server device 200. The device information of the peripheral devices 500 to 700 may include at least one of hardware information and software information related to the data processing types of the peripheral devices 500 to 700. When the peripheral devices newly access or are disconnected from the electronic device 100, the external device 300, the external device 400, or the network 800, the peripheral device database 251 may be updated. The peripheral device database 251 may provide information indicating what peripheral device is currently available through update of information. The peripheral device database 251 may store a history of jobs performed in response to requests from the electronic device 100, the external device 300 or the external device 400. The information stored in the peripheral device database 251 may be provided according to a sharing setting (or a sharing configuration) and the requests from the electronic device 100, the external device 300 or the external device 400.

The external device database 253 may include device identification information and device information of at least one of the external device 300 and the external device 400. The external device database 253 may be updated according to connection of the external device 300 and the external device 400 to the electronic device 100 or the network 800. The external device database 253 may include information on a communication connection state or a communication release state of each of the external device 300 and the external device 400. The external device database 253 may store a transmission history of data transmitted to the electronic device 100. The information stored in the external device database 253 may be provided according to a sharing setting in response to requests from the electronic device 100 and another external device.

The electronic device database 255 may include the device identification information and device information of the electronic device 100. The device information of the electronic device 100 may be updated according to installation or update of a program or replacement of hardware of the electronic device 100. Once the device information of the electronic device 100 is updated, the electronic device database 255 may receive the update information from the electronic device 100 to perform information update. The information stored in the electronic device database 255 may be provided to other electronic devices or external devices according to a sharing setting.

The server storage module 250 may store the data processing type information of the server device 200. The data processing type information of the server device 200 may be provided to the electronic device 100. The data processing type information of the server device 200 may be updated according to program installation or update or hardware update of the server device 200. Once the data processing type information of the server device 200 is updated, the updated information may be provided to the electronic device 100.

The sever control module 260 may support data transmission and processing and control signal transmission and processing in relation to support of data conversion processing of the server device 200. In relation to this operation, the server control module 260 may include a data conversion module 280.

The data conversion module 280 may receive a data conversion request from the electronic device 100 and may perform processing with respect to the data conversion request. Furthermore, the data conversion module 280 may perform processing with respect to a data conversion request from at least one of the external device 300, the external device 400 or a data conversion request from at least one of the peripheral devices 500 to 700. In relation to this operation, the data conversion module 280 may include an electronic device support module 281, an external device support module 283, and a peripheral device support module 285.

The electronic device support module 281 may support access of the electronic device 100 to the server device 200. The electronic device support module 281 may receive, from the electronic device 100, data to be converted and conversion target information (e.g., the electronic device 100, at least one of the peripheral devices 500 to 700, or at least one of the external device 300 and the external device 400). According to an embodiment, the electronic device support module 281 may receive, from the electronic device 100, the first data (at least a part of which is not matched to the data processing type of the electronic device 100) and the device information and the identification information of the electronic device 100. Furthermore, the electronic device support module 281 may receive conversion type selection information (e.g., PDF, XML, TXT or text, or an image) from the electronic device 100.

According to an embodiment, the electronic device support module 281 may identify the data processing type of the electronic device 100 on the basis of the device information thereof. The electronic device support module 281 may pre-verify a data processing type free from an error or loss among the data processing types of the electronic device 100 in an operation of conversion of the first data. According to an embodiment, the electronic device support module 281 may select a specific type from among the data processing types, for example, a relatively lightweight type or a relatively high-resolution type, according to a designated policy. The relatively lightweight type or the relatively high-capacity type may be selected from among data processing types free from an error or loss.

According to various embodiments, in the case where the electronic device support module 281 receives the conversion type selection information from the electronic device 100, the electronic device support module 281 may select a data processing type designated in the conversion type selection information. The electronic device support module 281 may convert the received first data so that the first data is matched to a selected data processing type. In relation to this operation, the electronic device support module 281 may check the data processing type of the first data, and may enable a renderer related to playback of the first data. On the basis of this operation, the electronic device support module 281 may perform playback of the first data without an error or loss.

The electronic device support module 281 may convert the played first data so that the first data is matched to a selected data processing type. For example, the electronic device support module 281 may convert the first data of a specific type (e.g., a PPT or PowerPoint presentation type of MS Office document) into the selected data processing type (e.g., a PDF type document). If an error or loss occurs in an operation of conversion based on conversion type selection information, the electronic device support module 281 may automatically convert the first data into another type free from an error or loss (e.g., a pre-verified data processing type free from an error or loss due to conversion of the first data, among the data processing types of the electronic device 100). Furthermore, the electronic device support module 281 may provide a guide on information converted into the other type through the electronic device 100.

The electronic device support module 281 may receive, from the electronic device 100, a request for conversion into the data processing type of another electronic device (e.g., the external device 300, the external device 400 or the peripheral devices 500 to 700). In this case, the electronic device support module 281 may send a request for conversion according to the data processing type to a corresponding support module, for example, the external device support module 283 or the peripheral device support module 285. According to various embodiments, the electronic device support module 281 may provide the data processing type information of the server device 200. If update of the data processing type information occurs, the electronic device support module 281 may provide update information to the electronic device 100.

According to various embodiments, in the case where the first data provided from the electronic device 100 is unable to be rendered normally, the electronic device support module 281 may install a program capable of rendering the first data. For example, in the case where the received first data is Visio-type data of MS Office, the electronic device support module 281 may check existence of a renderer utilized for playing the data. If the renderer does not exist, the electronic device support module 281 may install a Visio program of MS Office. In relation to this operation, the server device 200 may access another server device that provides a relevant program or renderer, to receive the program or renderer. According to various embodiments, the server device 200 may output a message for requesting installation of the program or renderer. According to an embodiment, the electronic device support module 281 may convert data such as a document into a document of a specific type, e.g., a PDF type, to provide the document to the electronic device 100. The electronic device support module 281 may store the converted data as the conversion data 257. In the case of audio data or video data, the electronic device support module 281 may convert the audio data or the video data into a lightweight streaming format that differs in type from the first data to store and provide the audio data or the video data to the electronic device 100.

According to various embodiments, in the case where the first data received from the electronic device 100 is complex content, the electronic device support module 281 may integrate a layout function with a control function to package the functions in the first data, and then may store or transmit the first data to the electronic device 100. For example, the electronic device support module 281 may generate type conversion data in the form of an applet by integrating HTML, CSS or Cascading Style Sheets) and JS or Java script functions. According to various embodiments, in order to support a layout function of a specific function (e.g., a PSD function of Adobe Photoshop), the electronic device support module 281 may provide type conversion data in which the HTML, CSS and JS functions are integrated and packaged by separately extracting images for each layer stored in a PSD. According to various embodiments, the electronic device support module 281 may convert the first data (e.g., a Word document, a PPT document, an XLS (Microsoft Excel file format) document, a HWP document, a GUL, etc.) into specific type conversion data (e.g., a PDF document, an XPS document, an image, or an applet). The electronic device support module 281 may convert the first data of a text type (e.g., a TXT document, an HTML document, or programming language files) into specific type conversion data (e.g., an HTML document, a PDF document, an XPS document, an image, or an applet). According to various embodiments, the electronic device support module 281 may convert the first data of an image type into type conversion data having another type of an image format. According to various embodiments, the electronic device support module 281 may convert the first data corresponding to multiple input files into type conversion data having a compression or archiving type (e.g., self-extracting/executing).

The first type conversion data obtained through conversion by the electronic device support module 281 may include a sub-function able to be performed in the electronic device 100. The sub-function may be determined according to the type of the first type conversion data. The sub-function may include, for example, rewind, fast-forward, playback, pause, rotation and an additional extended function (e.g., go-to-page) during a playback process of data. The peripheral device support module 285 may perform data conversion in response to a data type conversion request from a peripheral device (e.g., at least one of the peripheral devices 500 to 700 of FIG. 1). Alternatively, the peripheral device support module 285 may perform data conversion so that specific data is matched to the data processing type of the peripheral device, in response to a request from the electronic device support module 281. For example, the peripheral device support module 285 may generate the second type conversion data matched to the data processing type of the peripheral device to store or transfer the second type conversion data to the peripheral device. Here, the peripheral device support module 285 may transfer the second type conversion data and the identification information (e.g., address information) of the peripheral device to the electronic device 100 or the external device 300 and the external device 400.

According to various embodiments, the peripheral device support module 285 may convert the first data into the second type conversion data (having an output result at such a level as to be rendered by a renderer installed in an external device (e.g., a PC or personal computer) using a driver (e.g., a printer driver) selected according to the device information of a peripheral device (e.g., a printer). Upon receiving a request for type conversion of the first data together with a request for transmission, the peripheral device support module 285 may render the first data using the renderer of the second quality level of the server device 200 and then may convert the first data using the driver corresponding to the peripheral device according to the device information of the peripheral device, to thereby generate the second type conversion data. In relation to this operation, the peripheral device support module 285 may install the driver corresponding to the peripheral device in the server device 200.

According to an embodiment, the peripheral device support module 285 may extract format characteristics of the driver corresponding to the peripheral device or hardware or software characteristics thereof, and may convert the first data into the second type conversion data so that the second type conversion data is matched to the extracted format characteristics or hardware or software characteristics. According to an embodiment, the peripheral device support module 285 may perform data conversion using an installed driver. For example, the peripheral device support module 285 may convert the first data into the second type conversion data using a driver related to the peripheral device. Here, the driver may correspond to the renderer of the second quality level of the server device 200. Alternatively, the driver may correspond to a deriver applied to a general purpose OS. The peripheral device support module 285 may include a converter for extracting information on the driver corresponding to the peripheral device and for generating the second type conversion data on the basis of the information.

Since the peripheral device support module 285 generates the second type conversion data by converting the first data using the driver corresponding to the peripheral device, the electronic device 100 or an external device that has received the second type conversion data may transfer the second type conversion data to the peripheral device without performing additional processing. Even though the electronic device 100 or the external device does not include an additional driver related to operation of the peripheral device, the electronic device 100 or the external device may transfer the second type conversion data to the peripheral device to output the second type conversion data through the peripheral device. Therefore, for example, the electronic device 100 or the external device may lack a driver related to operation of the peripheral device.

The external device support module 283 may receive, from an external device (e.g., at least one of the external device 300 and the external device 400 of FIG. 1), a request for type conversion of specific data. In response to the request from the external device, the external device support module 283 may convert the data into a specific data processing type supportable by the external device to provide the converted data to the external device. The external device support module 283 may receive, from the electronic device support module 281, a request for conversion of specific data to be transferred to the external device. The external device support module 283 may select a data processing type on the basis of the device information of the external device, and may perform type conversion of the data according to the selected data processing type. Therefore, the external device support module 283 may generate the third type conversion data matched to the data processing type of the external device to store or transfer the third type conversion data to the external device.

According to various embodiments, a server device according to an embodiment may include a server communication module that receives content from the outside (e.g., the first data from the electronic device or the second data from the peripheral device), and a server control module that renders the content using a renderer related to the content (e.g., a renderer for playing the content at a quality level equal or similar to a specific quality level of the content or a renderer for playing the content at a specific quality level based on a general purpose OS) and converts the rendered content into content corresponding to a renderer of the electronic device or a driver of the peripheral device (e.g., generates the first type conversion data or the second type conversion data).

According to various embodiments, the server control module may render the content at such a quality level that the content is played in an external device in which a general purpose OS is installed.

According to various embodiments, server control module may convert the content so that converted content has a format identical to or different from a format of the content.

According to various embodiments, the server control module may convert the content so that converted content has a sub-function able to be performed in the electronic device, wherein the sub-function may be determined according to the content and may include at least one of rewind, fast-forward, playback, pause, rotation and an additional extension (e.g., go-to-page).

According to various embodiments, the server device may further include a server storage module for storing information on the electronic device and the peripheral device used for at least one of conversion of the content and transmission of the converted content.

According to various embodiments, the server control module may convert the content using the information on the driver related to the peripheral device.

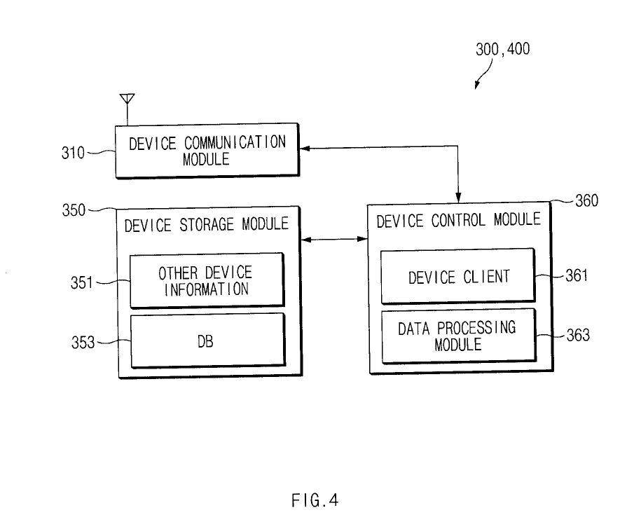

FIG. 4 is a block diagram illustrating an external device according to an embodiment.

Referring to FIG. 4, the external device according to an embodiment (e.g., the first external device 300 or the second external device 400, hereinafter the external device is assumed as the first external device 300) may include a device communication module 310, a device storage module 350, a device control module 360. Additionally or alternatively, the external device 300 may further include a device input module and a device output module.

The device communication module 310 may establish a communication channel to the electronic device 100. The device communication module 310 may transmit, to the electronic device 100, the first data corresponding to the data processing type of the external device in response to control by the device control module 360. According to various embodiments, the device communication module 310 may transmit the first data to the server device 200. In relation to this operation, the device communication module 310 may establish a communication channel to the server device 200 through the network 800. According to various embodiments, the device communication module 310 may receive the third type conversion data (e.g., data converted to be matched to the data processing type of the external device). The third type conversion data may be obtained by converting data transmitted from at least one of the electronic device 100 and the peripheral devices 500 to 700 to the server device 200. Alternatively, the third type conversion data may be obtained by converting data which is generated by a specific program installed in another external device and at least a part of which is not matched to the data processing type of the external device so that the data is matched to the data processing type of the external device.

The device storage module 350 may store various programs and data related to operation of the external device 300. According to an embodiment, the device storage module 350 may include other device information 351 and a database 353. The other device information 351 may include the device information (information related to a data processing type) and identification information (information utilized for establishing a communication channel to the electronic device or the peripheral devices 500 to 700) of at least one of the electronic device 100 and the peripheral devices 500 to 700. In the case of establishing a communication channel to the electronic device 100 or the peripheral devices 500 to 700, the external device 300 may request the device information of the electronic device 100 or the peripheral devices 500 to 700 to store the device information in the device storage module 350. The other device information 351 stored in the device storage module 350 may be provided to the server device 200. Alternatively, the other device information 351 may provide the device information and the identification information of the electronic device 100 or the peripheral devices 500 to 700 to which the first data is to be transferred, while providing the first data to the server device 200.

The database 353 may include at least one piece of the first data. The first data may include at least one of various data such as document data, audio data, image data or video data. The first data may be transferred to at least one of the electronic device 100, the peripheral devices 500 to 700 and the server device 200 according to control by a user input. The database 353 may include the third type conversion data provided from the server device 200.

The third type conversion data which is matched to the data processing type of the external device may correspond to the first data. The third type conversion data may be provided to the electronic device 100 and the peripheral devices 500 to 700 according to control by a user input. Alternatively, the third type conversion data may be transmitted back to the server device 200 together with a request for transfer to the electronic device 100 or the peripheral devices 500 to 700. The server device 200 may convert the third type conversion data into the first type conversion data corresponding to the data processing type of the electronic device 100 to provide the first type conversion data. The server device 200 may convert the third type conversion data into the second type conversion data corresponding to the data processing type of the peripheral devices 500 to 700.

The device control module 360 may control processing and transmission of data and control signals related to operation of the external device 300. The device control module 360 may include a device client 361 and a data processing module 363.

The device client 361 may control operation of a communication channel to the electronic device 100. For example, the device client 361 may perform a control operation utilized for transmitting the first data to the electronic device 100. The device client 361 may perform a control operation utilized for transmitting the first data to the server device 200. If the third type conversion data is received from the server device 200, the device client 361 may transfer the third type conversion data to the data processing module 363. The device client 361 may transmit specific data not matched to the data processing type of the external device 300 to the server device 200 in response to a user input, and may receive the third type conversion data from the server device 200.

The device client 361 may control establishment of communication channels to the peripheral devices 500 to 700 and transmission/reception of data to/from the peripheral devices 500 to 700. The device client 361 may perform a control operation so that the other device information 351 is collected and stored in the device storage module 350 when the peripheral devices 500 to 700 are connected wirelessly or by wire. If the second type conversion data requested to be transferred to the peripheral devices 500 to 700 is received from the server device 200, the device client 361 may perform a control operation so that the second type conversion data is transferred to the peripheral devices.

The data processing module 363 may process the third type conversion data. The data processing module 363 may activate a program related to processing of the third type conversion data, and may process playback of the third type conversion data. According to various embodiments, the data processing module 363 may support data type conversion of the server device 200. For example, in the case where the first data is received from the electronic device 100, the data processing module 363 may convert the first data into the first type conversion data (e.g., a PDF document) matched to the data processing type of the electronic device 100 to provide the first type conversion data to the electronic device 100. According to various embodiments, in the case where the second data is received from a peripheral device connected to the external device 300 in response to a request from the peripheral device (e.g., the peripheral devices 500 to 700) or a request from the electronic device 100, the data processing module 363 may convert the second data into the first type conversion data (e.g., a PDF document) matched to the data processing type of the electronic device 100 to provide the first type conversion data to the electronic device 100.

According to various embodiments, a data conversion processing system according to an embodiment may include an electronic device including a first renderer. The first renderer may play content at a relatively low quality level, in situations where the content is not subjected to additional data conversion (e.g. of format or type), and particularly where hardware or software applications of an executing mobile device are limited in their rendering or output capability. However, it is desired that the electronic device play content of at a specific quality level, or a better quality level, as might be had if utilizing an external device operating a general purpose OS including a software suite or program operable to play the content at the specific or quality level. A server device may be configured to play the content at the specific quality level using a second renderer, and generate converted data output from the electronic device at a quality level equal or similar to the specific quality level by converting the content played using the second renderer to provide the converted data to be transmitted to the electronic device.

After receiving the converted data, the electronic device may play, sound, display or otherwise output the converted data using a third renderer different from the first renderer. For example, the content of the specific quality level may be played at the specific quality level by the second renderer (e.g. a renderer of a PPT file of MS Office). The first renderer may be unable to play the content at the specific quality level or may not be capable of outputting or playing back the converted data (e.g., because of a post-conversion incompatibility in a software suit or program customized for a particular hardware environment). The third renderer may be a renderer (e.g., a PDF file renderer) that outputs the converted data without loss of any stored information content while maintaining output of the specific quality level. Therefore, the server device may generate conversion data capable of output at a quality level equal or similar to the specific quality level by the electronic device's third renderer, by using the second renderer to convert the content into the converted data for use with the third renderer.

According to various embodiments, the server device may convert the content into the type conversion data of the specific quality level using a driver identical to a driver of a peripheral device connected to the electronic device to provide the type conversion data to the peripheral device.

According to various embodiments, the electronic device may receive the content converted to correspond to the peripheral device and may provide the content to the peripheral device.

According to various embodiments, a data conversion processing system according to an embodiment may include an electronic device not including a renderer capable of rendering specific content or including a first renderer of a low quality level, and a server device that renders the content using a second renderer of a high quality level and converts the content output using the second renderer so that the content corresponds to the electronic device or a peripheral device to provide the converted content to the electronic device.

Here, the first renderer of the low quality level may have a source content representation rate that is equal to or lower than a certain value or is lower than that of the second renderer. The second renderer of the high quality may have a source content representation rate that is relatively higher than that of the first renderer operated on the basis of hardware or software installed in the electronic device or is equal to or higher than a predetermined certain value (e.g., a renderer that renders content at a quality level equal or similar to a quality level of a renderer operated in a general purpose OS). The source content representation rate may include at least one of the above-mentioned criteria of a representation rate.

According to various embodiments, the source content representation rate may be defined according to a value of comparison with resolution of content defined during a generation process of the content. For example, a resolution of specific content output by the first renderer installed in the electronic device, a resolution of the specific content output by the second renderer installed in the external device, and a resolution of the specific content output by the third renderer (e.g., a driver) installed in the peripheral device may be criteria for calculating the source content representation rate.

According to various embodiments, even though renderers have the same data processing type, the source content representation rates of the renders may be different from each other according to hardware or software characteristics of devices in which the renderers are installed. For example, a file editor installed in the external device (e.g., a PC) may support a relatively higher resolution than that supported by a file editor installed in the electronic device (e.g., a mobile device), or may have more various data processing elements. Therefore, the server device may collect information related to specific content during a rendering process of the specific content to support playback of the content at a quality level set for the content. Here, if a renderer related to the content is not installed, the server device may search for and install the renderer.

According to an embodiment, the content may be set to a quality level of a renderer installed to be matched to hardware or software characteristics of a specific external device. The server device may render the content using a renderer having the same quality level as that of the renderer installed in the external device. Here, the server device may convert the rendered content so that the rendered content corresponds to the device information of the electronic device or the peripheral device to provide the rendered content.

According to various embodiments, as described above, the quality level of content may be digitized by not only a source rendering representation rate of the content obtained when the content is rendered by a specific renderer in a specific device (e.g., the electronic device, the external device, the server device, or the peripheral device) but also at least one of an error occurrence rate with respect to data processing, a data loss rate, a scale matching rate, and a matching rate of at least one object contained in the content.

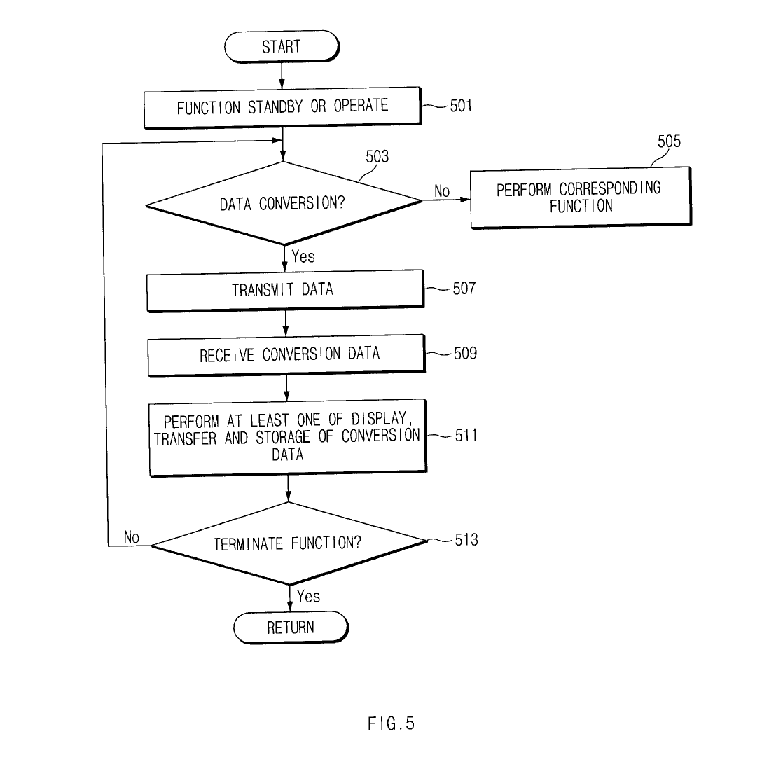

FIG. 5 is a flowchart illustrating an electronic device operating method related to data conversion processing according to an example embodiment.

Referring to FIG. 5, according to the electronic device operating method according to an embodiment, the control module 160 may execute another operation or wait in a standby state in operation 501. For example, the control module 160 may execute and display a specific function corresponding to a state, such as a sleep mode state, a lock screen state, a standby screen state or a menu screen state. According to an embodiment, the control module 160 may control performance of a mobile communication function, a web access function or the like of the electronic device 100. According to an embodiment, the control module 160 may support a function for retrieving at least one piece of data stored in the storage module 150.

The control module 160 may determine whether an event related to or requesting data conversion occurs in operation 503. For example, the control module 160 may determine whether a request is received for converting a first data incompatible with data processing capability of the electronic device 100 is made (e.g., for software or hardware issues). According to various embodiments, the control module 160 may determine whether the request was received from the external device 300, the external device 400 or the peripheral devices 500 to 700 is made. Similarly, if a request is received to playback the first data (which is incompatible with the electronic device 100) occurs, the control module 160 may also recognize the event as a request for converting the first data.

If there is no request for data conversion in operation 503, the control module 160 may proceed to operation 505 to control performance of a function according to, for example, the type of an event occurrence. For example, the control module 160 may release a sleep mode or a lock screen mode, or may support execution and performance of a specific function according to the event or the type of the event. If there is no event, the control module 160 may maintain a previously state, function, or may transition to a sleep mode.

If an event related to a data conversion request occurs in operation 503, the control module 160 may execute data transmission in operation 507. According to an embodiment, the control module 160 may transmit to the server device 20, the first data provided from at least one of the external device 300 and the external device 400. According to an embodiment, the first data may be retrieved from storage in the storage module 150 for transmission. In this operation, the control module 160 may also provide the relevant device information of the electronic device 100 to the server device 200.

According to various embodiments, the control module 160 may transmit, to the server device 200, conversion information selecting, for example a data type related to a data processing type. The control module 160 may, for example, have previously displayed a screen for selecting a type of data desired for conversion to receive and generate the type conversion selection information. For example, if a request for playback of the first data is made or the first data received from the outside is requested to be played, the control module 160 may analyze characteristics of the first data, and may provide a generated list of possible types for conversion that differ from the data types compatible with the data processing functionality of the electronic device 100. The type conversion list may also include data processing types that are able to be processed in the electronic device 100, for example, PDF, HTML, XML and a specific image type. The control module 160 may detect a selection event indicating one of the items of the list as the desired data type for conversion and transmit the type conversion selection information to the server device 200.

According to an embodiment, upon receiving the first data and the device information (or type conversion selection information) from the electronic device 100, the server device 200 may generate the converted first type data matched the data processing type corresponding to the device information. According to another embodiment, the server device 200 may generate the converted first type data corresponding to a data processing type designated by the received type conversion selection information. The server device 200 may transmit the converted first type data back to the electronic device 100.

The control module 160 may receive the converted data in operation 509. For example, the control module 160 may receive the converted first type data, generated from the server device 200 processing or rendering the first data previously transmitted to the server device 200. The converted first type data may now correspond to a data type executable, accessible or otherwise processable by the electronic device 100. When the first type conversion data is played in the electronic device 100, the same contents as those of the first data may be output without an error or loss.

The control module 160 may process at least one of display, transfer and storage of the conversion data in operation 511. In relation to this operation, in the case of receiving the first type conversion data, the control module 160 may allow the first type conversion data to be output to the display module 140 by default. Alternatively, the control module 160 may allow the first type conversion data to be stored in the storage module 150. According to various embodiments, the control module 160 may transfer the first type conversion data to another designated electronic device.

The control module 160 may determine whether an event related to functional termination occurs in operation 513. If it is determined that the event related to functional termination does not occur in operation 513, the control module 160 may return to operation 503 to re-perform operation 503 and the following operations. If it is determined that the event related to functional termination occurs in operation 513, the control module 160 may return to operation 501 or 505.

According to various embodiments, a data conversion processing method according to an embodiment may include receiving type conversion data obtained by converting data, at least a part of which is not matched to the data processing type of the electronic device or another electronic device, so as to match the data to the data processing type, and performing at least one of output, storage or transmission of the received type conversion data.

According to various embodiments, the method may further include transmitting device support information related to the data processing type of the electronic device to the server device that generates the type conversion data.

According to various embodiments, the performing may further include controlling output of the type conversion data using a function different from a function for outputting the data.

According to various embodiments, the method may further include transmitting device support information related to the data processing type of the other electronic device to the server device that generates the type conversion data.

According to various embodiments, the performing may include transmitting, to the other electronic device, type conversion data obtained through conversion based on the data processing type of the other electronic device upon receiving the type conversion data.

According to various embodiments, the method may further include transmitting the data corresponding to the data processing type of the other electronic device to the server device that generates the type conversion data if the data is received from the other electronic device.

According to various embodiments, the method may further include transmitting, to the server device that generates the type conversion data, data corresponding to the data processing type of the other electronic device pre-stored in response to the occurrence of an input event.

According to various embodiments, the performing may further include removing the pre-stored data and storing the type conversion data when the type conversion data is received.

According to various embodiments, the method may further include storing information on the data processing type of the server device that generates the type conversion data, and determining whether to transmit the data on the basis of information on a data processing state of the server device.

According to various embodiments, the method may further include updating the information on the data processing type of the server device in response to at least one of program installation, program update and hardware replacement of the server device.

According to various embodiments, a method for operating an electronic device according to an embodiment may include transmitting, by the communication interface, data including content in a first format (e.g., data that undergoes the occurrence of an error or data loss or differs in scale ratio or content arrangement position from a display when being displayed on the electronic device, or data at least a part of which is not matched to the data processing type of the electronic device) or data representing the content to the outside of the electronic device, receiving, by the communication interface, data including the content in a second format (e.g., data compatible with the electronic device) from the outside of the electronic device, and displaying the content in the second format by a display that is included in the electronic device or is connectable to the electronic device wirelessly or by wire, wherein the electronic device is unable to display at least one of objects included in the content in the first format, but is able to display the at least one of objects when displaying the content in the second format.

According to various embodiments, the first format may include a web document format.

According to various embodiments, the second format may include at least one of PDF, PDL, HTML, XPS, an image and an applet.

According to various embodiments, at least one of the objects may include at least one of an image, a picture, a captured scene of a video, and an advertisement.

According to various embodiments, the method may further include displaying at least a part of the content in the first format on the display before transmitting the content in the first format to the outside of the electronic device.

According to various embodiments, the method may include transmitting the content in the first format to the outside of the electronic device in response to at least a part of an input from a user.

According to various embodiments, the method may include transmitting the content in the first format to the outside of the electronic device according to determination of the electronic device without receiving the input from the user.

According to various embodiments, the method may include, for the determination of the electronic device, determining, by the electronic device, whether the content in the first format includes an object unable to be displayed by the electronic device.

According to various embodiments, the method may further include transmitting, by the communication module, the content in the second format to the outside of the electronic device.

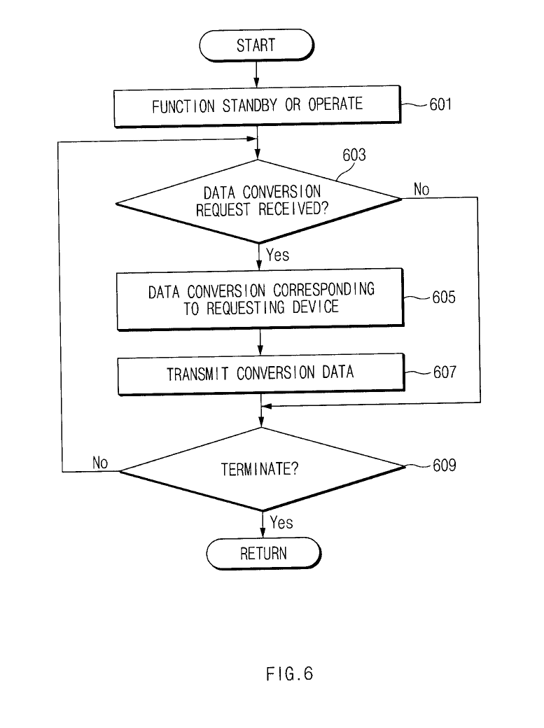

FIG. 6 is a flowchart illustrating a server device operating method related to data conversion processing according to an embodiment.

Referring to FIG. 6, according to the server device operating method related to data conversion processing, the server control module 260 of the server device 200 may allow operation performance or standby in operation 601. For example, the server device 200 may supply power to the server communication module 210 in order to support access by the electronic device 100, the external device 300, the external device 400, or the peripheral devices 500 to 700. According to various embodiments, the server device 200 may establish a communication channel to at least one of the electronic device 100, the external device 300, the external device 400 or the peripheral devices 500 to 700.

The server control module 260 may determine whether a data conversion request is received in operation 603. According to an embodiment, the server control module 260 may determine whether a request for first type conversion of the first data (request for the first type conversion data matched to the data processing type of the electronic device 100) is received from the electronic device 100, the communication channel to which has been established. According to an embodiment, the server control module 260 may determine whether a request for second type conversion of the first data (request for the second type conversion data matched to the data processing type of a specific peripheral device) is received from the electronic device 100. According to an embodiment, the server control module 260 may determine whether a request for third type conversion of the first data (request for the third type conversion data matched to the data processing type of a specific external device) is received from the electronic device 100. According to an embodiment, the server control module 260 may determine whether a request for second type conversion of the second data is received from a specific peripheral device, the communication channel to which has been established. According to an embodiment, the server control module 260 may determine whether a request for first type conversion or second type conversion of the third data is received from an external device, the communication channel to which has been established.

If a data conversion request is received in operation 603, the server control module 260 may perform data conversion corresponding to a requesting device in operation 605. According to an embodiment, the server control module 260 may check the device information of the electronic device 100 that has transmitted the first data to check the data processing type corresponding to the electronic device 100. The server control module 260 may generate the first type conversion data matched to the data processing type of the electronic device 100 on the basis of the first data. According to an embodiment, the server control module 260 may generate the second type conversion data matched to the data processing type of the specific peripheral device on the basis of the first data. According to an embodiment, the server control module 260 may generate the third type conversion data matched to the data processing type of the specific external device on the basis of the first data. According to an embodiment, the server control module 260 may generate the first type conversion data matched to the data processing type of the electronic device on the basis of the second data provided from the specific peripheral device or the third data provided from the specific external device. According to an embodiment, the server control module 260 may generate the third type conversion data matched to the data processing type of the peripheral device on the basis of data provided from the electronic device 100, the specific external device or another peripheral device. In this operation, the server control module 260 may determine a data processing type into which data is to be converted in response to a request from a device that has transmitted the data.

The server control module 260 may control transmission of conversion data in operation 607. According to an embodiment, the server control module 260 may transmit the conversion data to a device that has requested data conversion. According to an embodiment, the server control module 260 may transmit the conversion data to a device designated to receive the conversion data.

It may be determined whether an event related to termination occurs in operation 609. If a termination-related event occurs, the server control module 260 may control termination of operation of the server device 200. If the termination-related event does not occur, the server control module 260 may return to operation 601 to re-perform operation 601 and the following operations.

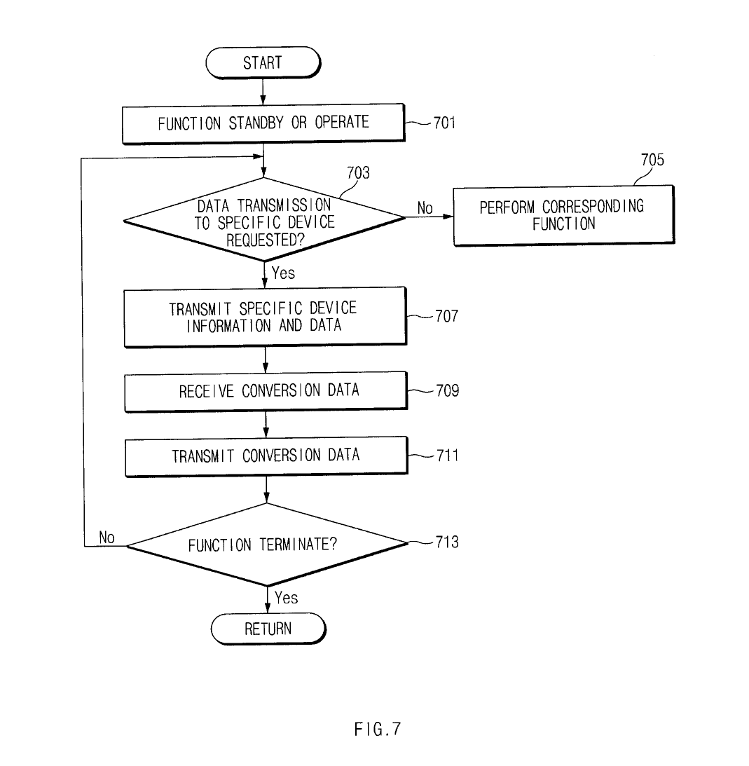

FIG. 7 is a flowchart illustrating an external device operating method related to data conversion processing according to an embodiment.

Referring to FIG. 7, according to the external device operating method related to data conversion processing, the device control module 360 of an external device (e.g., at least one of the first external device 300 and second external devices 400) may allow operation performance or standby in operation 701. For example, the device control module 360 may control performance of a function provided by the external device, such as a sound source playback function or a video playback function, in response to a user input.

The device control module 360 may determine whether an event of requesting data transmission to a specific device occurs in operation 703. For example, the device control module 360 may determine whether an event of requesting transmission of the first data (data matched to the data processing type of the external device) stored in the device storage module 350 occurs.

If an event related to data transmission does not occur in operation 703, the device control module 360 may control performance of a function according to an event that occurs in operation 705. For example, the device control module 360 may control a function that is currently being performed or may control performance of a new function according to an event type. Alternatively, if there is no event, the device control module 360 may maintain a previous function performing state or may control sleep mode transition.

The device control module 360 may transmit specific device information and data in operation 707. For example, the device control module 360 may collect the device information and the identification information of a device to which the first data is to be transmitted, and may transmit the collected device information and identification information of a specific device and the first data to the server device 200. For example, the device control module 360 may transmit the device information of the peripheral device connected to the external device 300 and the first data to the server device 200. For example, the device control module 360 may transmit the device information and the device identification information of the electronic device connected to the external device 300 and the first data to the server device 200.

According to an embodiment, the server device 200 may check the data processing type of the peripheral device on the basis of the device information of the peripheral device, and may generate the second type conversion data matched to the data processing type to provide the second type conversion data to the external device. According to various embodiments, the server device 200 may check the data processing type corresponding to the device information of the electronic device 100, and may generate the first type conversion data matched to the data processing type. The server device 200 may provide the first type conversion data to the electronic device 100 on the basis of the identification information of the electronic device 100.

The device control module 360 may receive conversion data in operation 709. In the case of providing type conversion data to the peripheral device connected to the external device, the device control module 360 may receive the conversion data from the server device 200. The device control module 360 may transmit the conversion data in operation 711. For example, the device control module 360 may transmit the conversion data to the peripheral device.

According to an embodiment, in the case where the server device 200 transmits the first type conversion data generated on the basis of the first data to the electronic device 100, the device control module 360 may skip operations 709 and 711.

The device control module 360 may determine whether an event related to functional termination occurs in operation 713. If the event related to functional termination does not occur, the device control module 360 may return to operation 703 to re-perform operation 703 and the following operations. If the event related to functional termination occurs, the device control module 360 may return to operation 701 or 705 to perform a corresponding operation.

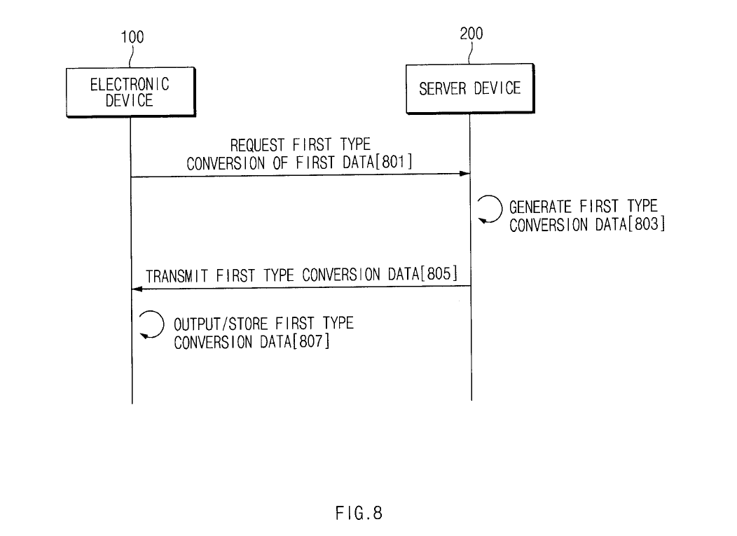

FIG. 8 is a diagram illustrating data conversion processing between an electronic device and a server device according to an embodiment.

Referring to FIG. 8, the electronic device 100 may transmit a request for conversion of the first data to a first type of data to the server device 200 in operation 801. In this operation, the electronic device 100 may transmit the first data and the device information of the electronic device 100 to the server device 200. According to an embodiment, the electronic device 100 retrieves data stored in the storage module 150 for the transmission. If playback of specific data (e.g., the first data) is requested, the control module 160 may detect the processing type of the first data. The control module 160 may search programs installed in the electronic device 100 to determine whether a program (e.g., a renderer, player or a viewer) suitable for playing the first data exists. If the program for playing the first data does not exist, the control module 160 may display a guide for requesting approval for selecting a type of data in which to effect conversion of the first data. If the request for a particular type of data for conversion is approved (e.g., by a user input), the control module 160 may transmit this information to the server device 200.

The server device 200 may generate the converted data in the first type (or format) on the basis of the first data in operation 803. The server device 200 may check the processing type, format, kind, etc. of the first data, and may activate a program for playing, viewing or otherwise outputting the first data. For example, in the case where the first data is PPT-type data of MS Office, the server device 200 may activate a PPT program (e.g., a PPT viewer). Here, the server device 200 may detect version information of the first data and thus activate a corresponding version of a PPT program. If the corresponding version of the PPT program does not exist, the server device 200 may retrieve the corresponding version of the PPT program from another server and thereby install the corresponding version of the PPT program. The server device 200 may perform playback, display or outputting of the first data (which in this case, is playback without an error or loss) using the program related to the first data.

The server device 200 may select a data processing type or format compatible with the known functionality of the electronic device 100 on the basis of the device information provided from the electronic device 100. For example, the server device 200 may detect whether a program having or compatible with a type or kind related to or similar to the first data exists among the programs installed in the electronic device 100. The server device 200 may then select, from among the programs having a similar type or compatibility, a specific data processing type (e.g., a specific program) that supports playback of relatively low-resolution data or high-resolution data (ex. relatively lightweight data or big data).

The server device 200 may convert the first data so that the first data is formatted to be compatible with the selected data processing type. Here, if a value of an error or loss is equal to or larger than a certain value or a value of scale difference is equal to or larger than a certain value during the first data conversion process, the server device 200 may replace the data processing type with another data processing type. For example, if at least one of a value of data loss, a value of data error, or a value of a degree of scale change is equal to or larger than a set value while the first data is converted to another type (such as a “.txt” or text type), the server device 200 may perform a control operation so that the first data is converted into another format (such as a “PDF”). Alternatively, when the data processing type for the conversion of the first data is selected, the server device 200 may detect data conversion guarantee ratios of data processing types (each program) of the electronic device 100. Here, the data conversion guarantee ratio may be a non-matching ratio (a ratio of data converted to be different from a source due to an error or loss) guaranteed by a data processing type (or program) with respect to the occurrence of a data error or loss during a process of converting the first data into the data processing type. The data conversion guarantee ratio may vary with the type of the first data and the data processing program. The electronic device 100 may perform conversion of the first data into a data processing type having a highest data conversion guarantee ratio among the data processing types. According to various embodiments, the server device 200 may select a data processing type having a high resolution with at least a certain value, even though the data processing type has a relatively low data conversion guarantee ratio (e.g., a relatively high data error or loss occurrence ratio).

In cases where the electronic device 100 provides type conversion selection information, the server device 200 may convert the first data into a data processing type corresponding to the type conversion selection information. Here, in the case where a non-matching ratio such as an error value, a data loss value or a schedule adjusting ratio of the first type conversion data obtained through conversion based on the type conversion selection information is equal to or higher than a predetermined value, the server device 200 may generate the first type conversion data according to a specific data processing type having a relatively high data conversion guarantee ratio for the first data.

The server device 200 may transmit the converted data to the electronic device 100 in operation 805. While transmitting the converted data to the electronic device 100, the server device 200 may transmit the converted data obtained through conversion based on the type conversion selection information and the first type conversion data obtained through conversion based on the data processing type of which the data conversion guarantee ratio is equal to or higher than a certain value. Alternatively, the server device 200 may transmit the first type conversion data corresponding to the type conversion selection information according to a request from the electronic device 100. Alternatively, the server device 200 may transmit, to the electronic device 100, the first type conversion data having a determined data conversion guarantee ratio.

The electronic device 100 may output or store the converted data in operation 807. The electronic device 100 may output the converted data to the display module 140 or the audio module 130 utilizing a program corresponding to the type conversion selection information. Alternatively, the electronic device 100 may store the first type conversion data as the conversion information 155 in the storage module 150. Here, the electronic device 100 may remove the first data and replace it by storing the first converted data alone as the conversion information 155.

According to various embodiments, the control module 160 may automatically access the server device 200 if a program suitable for playing the first data does not exist in operation 801. In this operation, if the server device 200 is not accessible, the control module 160 may notify that the server device 200 is not accessible. Furthermore, the control module 160 may propose selection of a program that is similar in type to the first data. Alternatively, the control module 160 may play the first data using the program that is similar in type to the first data. For example, the control module 160 may control playback of the first data on the basis of a document playback program if the first data has a document type. The control module 160 may control playback of the first data on the basis of an image playback program if the first data is an image.

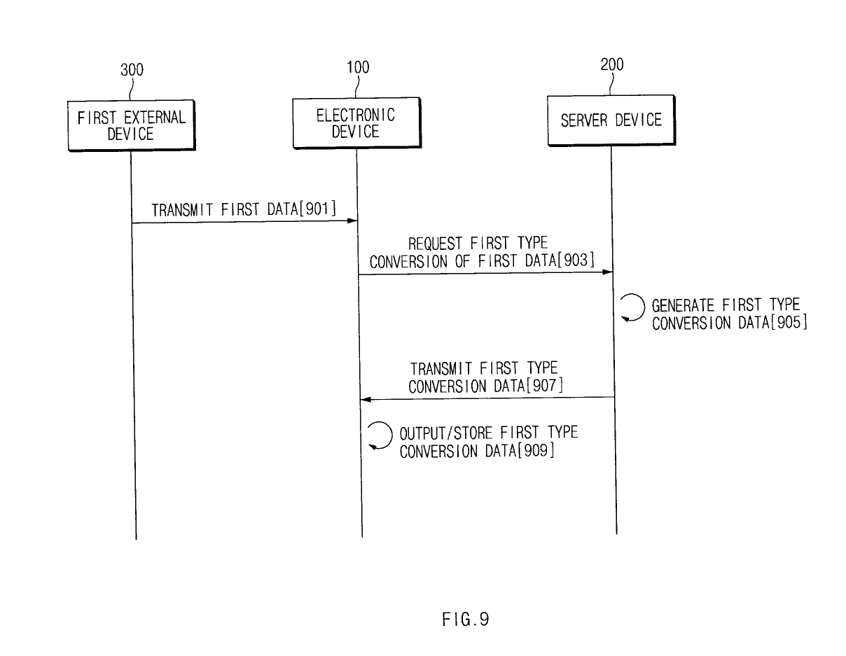

FIG. 9 is a diagram illustrating data conversion processing among an electronic device, a server device and a first external device according to an embodiment.

Referring to FIG. 9, the first external device 300 may transmit the first data to the electronic device 100 in operation 901. In relation to this operation, the first external device 300 may establish a communication channel to the electronic device 100. For example, the first external device 300 may establish a short-range communication channel or a direct communication channel (e.g., a Wi-Fi direct communication channel or a Bluetooth communication channel) to the electronic device 100. The first external device 300 may transmit the first data stored in the device storage module 350 to the electronic device 100 in response to a user input. According to various embodiments, the first external device 300 may receive a request for transmission of the first data from the electronic device 100, and may transmit the first data to the electronic device 100 in response to the request. In relation to this operation, the first external device 300 may provide a data list to the electronic device 100 to support a user of the electronic device 100 so that the user of the electronic device 100 selects the first data.

While transmitting the received first data to the server device 200, the electronic device 100 may make a request for first type conversion in operation 903. The control module 160 of the electronic device 100 may check the type of the first data transmitted from the first external device 300 to determine whether the first data is able to be processed on the basis of the data processing types (e.g., installed programs) installed in the electronic device 100. Alternatively, the control module 160 of the electronic device 100 may determine whether a data processing type (e.g., a specific type) of which a non-matching ratio is equal to or lower than a certain value at the time of playing the first data exists, the non-matching ratio including at least one of an error value, a loss value or a schedule adjusting ratio. If there is no data processing type of which the non-matching ratio is equal to or lower than a certain value with respect to playback of the first data, the control module 160 may make a request for first type conversion, while transmitting the first data to the server device 200. Here, the electronic device 100 may provide, to the server device 200, the identification information (e.g., network address information of the electronic device 100) of an electronic device that is to receive the first type conversion data, for example, the electronic device 100.

The server device 200 may generate the first type conversion data on the basis of the first data in operation 905. The server device 200 may transmit the first type conversion data to the electronic device 100 in operation 907. The electronic device 100 may output or store the first type conversion data in operation 909.

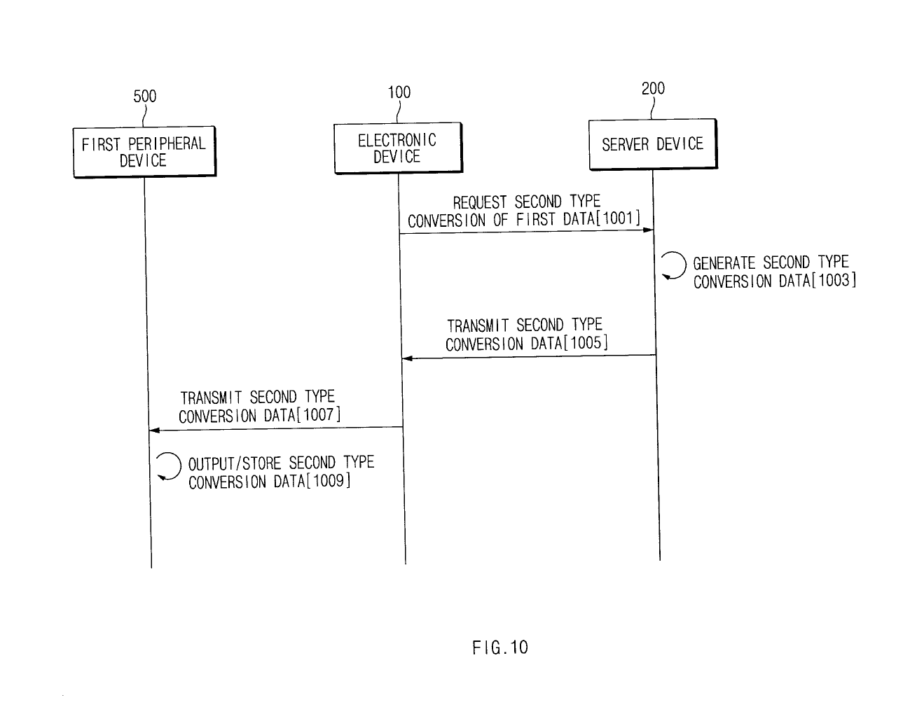

FIG. 10 is a diagram illustrating data conversion processing among an electronic device, a server device and a first peripheral device according to an embodiment.

Referring to FIG. 10, the electronic device 100 may make a request for conversion of data to a second type or format while transmitting the first data to the server device 200 in operation 1001. According to an embodiment, the electronic device 100 may provide a function of retrieving data stored in the storage module 150, and may receive an event related to transmission of specific data to another electronic device (e.g., the external device 300, the external device 400 or the peripheral devices 500 to 700). In relation to this operation, the electronic device 100 may provide a menu item related to transmission of the first data to the other electronic device. If a request for transmitting the first data to the other electronic device is made, the electronic device 100 may perform a periphery search or may collect information on at last one other electronic device connected to the electronic device 100. Furthermore, the electronic device 100 may display a list of discovered other electronic devices. If a specific other electronic device is selected, the electronic device 100 may collect the identification information and the device information of the selected other electronic device. Therefore, the electronic device 100 may make a request for conversion to the second type for compatibility with the other electronic device, while transmitting the collected identification information and device information of the other electronic device to the server device 200 together with the first data. According to an embodiment, the control module 160 of the electronic device 100 may collect the device information of the first peripheral device 500 connected to the electronic device 100 through a cable or a wireless communication channel. Here, the first peripheral device 500 may be a printer, an external memory device, an external display device, a projector, or an external speaker.

The server device 200 may generate the second type conversion data on the basis of the first data in operation 1003. Here, the server device 200 may check the data processing type of the first peripheral device 500 through the device information of the first peripheral device 500 provided from the electronic device 100. A program utilized for converting the first data may be pre-installed in the server device 200, or may be received from another server in order to be installed in the server device 200. In this operation, the server device 200 may determine whether the device information of the first peripheral device 500 mapped to pre-installed drivers exists. If driver information related to the first peripheral device 500 is not retrieved (or retrieval of the driver information fails), the server device 200 may send a request to the electronic device 100 to obtain the driver information, and may install a driver. The server device 200 may perform data type conversion based on a driver related to the first peripheral device 500 to generate the second type conversion data.

The server device 200 may transmit the second type conversion data to the electronic device 100 in operation 1005. In relation to this operation, the electronic device 100 may request the server device 200 to send the second type conversion data to the electronic device 100, while requesting the second type conversion from the server device 200. Therefore, the server device 200 may transmit the second type conversion data to the electronic device 100.

The electronic device 100 may transmit the second type conversion data to the first peripheral device 500 in operation 1007. Here, the first peripheral device 500 may be connected to the electronic device 100 through a direct communication channel or a wired cable. The first peripheral device 500 may output or store the second type conversion data in operation 1009. For example, when the first peripheral device 500 receives the second type conversion data obtained through conversion for compatibility with the data processing type of the first peripheral device 500, the first peripheral device 500 may print the received data, may output the received data to a display device or a projector, or may store the received data in a certain memory area.

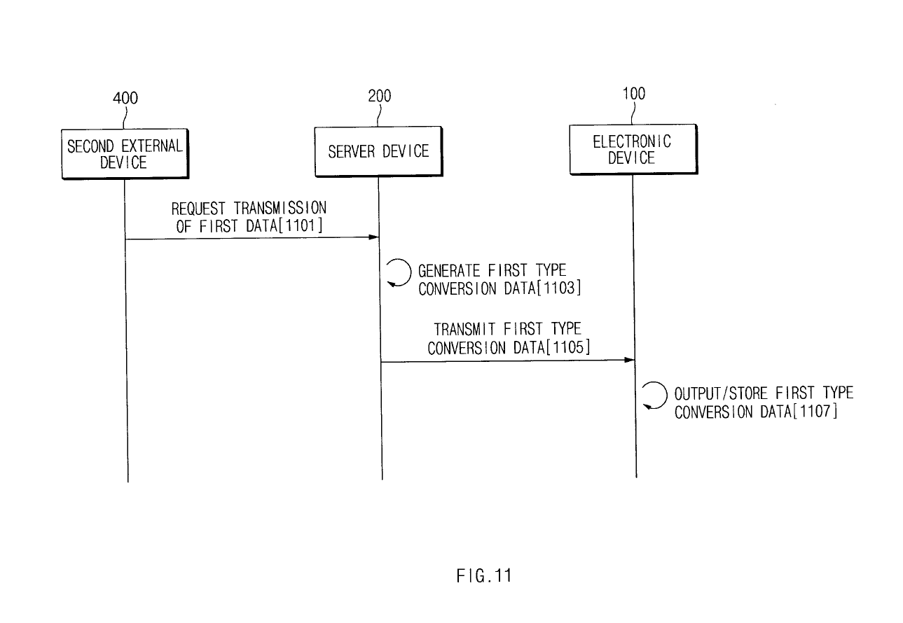

FIG. 11 is a diagram illustrating data conversion processing among an electronic device, a server device and a second external device according to an embodiment.

Referring to FIG. 11, the second external device 400 may request the server device 200 to transmit the first data to the electronic device 100, while transmitting the first data to the server device 200 in operation 1101. In relation to this operation, the second external device 400 may provide the first data and the identification information and the device information of the electronic device 100 to the server device 200. Additionally or alternatively, the second external device 400 may provide the identification information thereof to the server device 200. Here, in the case where the server device 200 stores the device information of the electronic device 100 in advance, the second external device 400 may not provide the device information of the electronic device 100 to the server device 200.

According to various embodiments, the second external device 400 may upload a data list stored in a device storage module to the server device 200 to share the data list with the electronic device 100. The electronic device 100 may access the server device 200 to check the data list of the second external device 400, and may select specific data (e.g., the first data) to make a request for transmission of the specific data. In response to this request, the second external device 400 may request the server device 200 to transmit the first type conversion data obtained through conversion of the first data to the electron device 100, while transmitting the first data to the server device 200.

According to various embodiments, the second external device 400 may share data with the electronic device 100. For example, the second external device 400 may provide information so that a list of data stored in the device storage module 350 is checked by the electronic device 100. If the second external device 400 receives, from the electronic device 100, a request for transmission of specific data stored in the device storage module 350, the second external device 400 may request the server device 200 to convert the specific data into the first type conversion data and then transmit the first type conversion data to the electronic device 100.

The server device 200 may generate the first type conversion data on the basis of the first data in operation 1103. The server device 200 may generate the first type conversion data matched to the data processing type of the electronic device 100 using the first data. Here, the first type conversion data may include the identification information of the second external device 400 as transmitter information. For example, the server device 200 may add, to the first type conversion data, network address information of the second external device 400, at least one of name information of the second external device 400, nickname information of the second external device, a time of requesting transmission of the first data, or the identification information of the electronic device 100 that is to receive the first data. The server device 200 may transmit the first type conversion data to the electronic device 100 in operation 1105.

The electronic device 100 may output or store the first type conversion data in operation 1007. Here, the electronic device 100 may output the identification information of the second external device 400 included in the first type conversion data together with the first data corresponding to the first type conversion data.

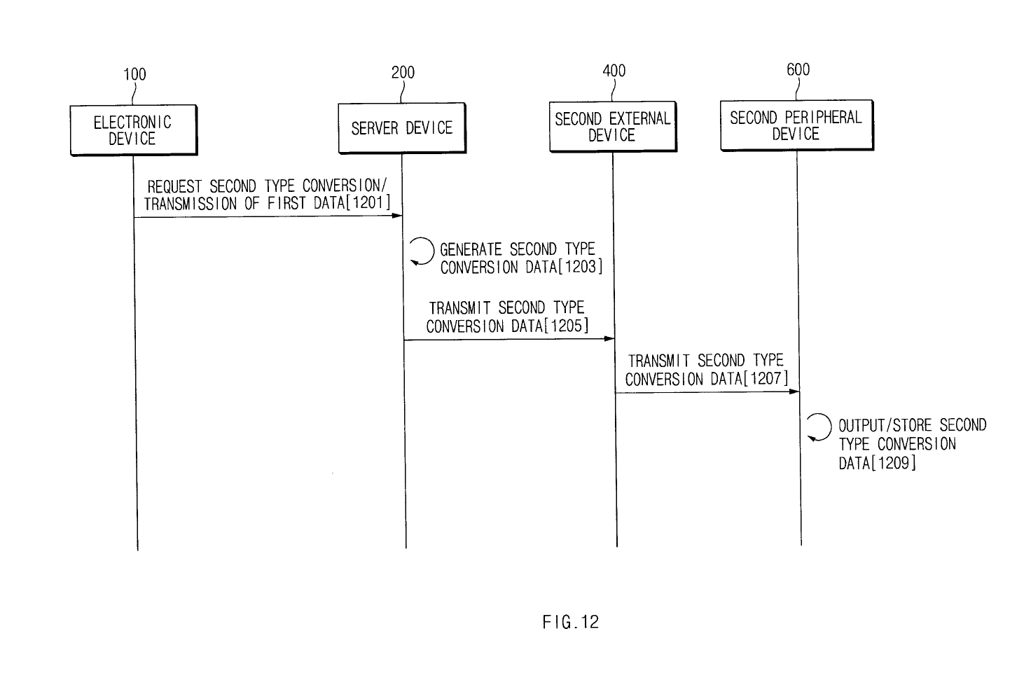

FIG. 12 is a diagram illustrating data conversion processing among an electronic device, a server device, a second external device and a second peripheral device according to an embodiment.

Referring to FIG. 12, the electronic device 100 may make a request for second type conversion of the first data and transmission of the converted data to the second peripheral device 600, while transmitting the first data to the server device 200 (before transmitting the first data, after transmitting the first data, or at the same time as the first data) in operation 1201. Here, the second peripheral device 600 may be connected to the second external device 400. The second external device 400 may be connected to the server device 200 through the network 800. The server device 200 may provide, to the electronic device 100, the second external device 400 connected to the server device according to a sharing function setting. For example, the second external device 400 may determine whether to accept notification of an access state of the second external device 400 and a data sharing function, while accessing the server device 200. If the access state notification and the data sharing function are accepted, the server device 200 may provide information on the access state and data sharing of the second external device 400 to other devices connected to the server.

When the electronic device 100 accesses the server device 200 through the network 800, the electronic device 100 may receive information on other devices that have accepted the sharing function, for example, information on the second external device 400. The electronic device 100 may determine that the second peripheral device 600 is connected to the second external device 400 on the basis of access information of the second external device 400. In relation to this operation, the second external device 400 may provide connection state information of the second peripheral device 600 to the server device 200.

The electronic device 100 may receive an event (e.g., a user input) related to output of specific data to the second peripheral device 600 or storage of the specific data in the second peripheral device 600. In relation to this operation, the electronic device 100 may support operation related to a data retrieval screen, a data transmission menu and selection of the second peripheral device 600. If the electronic device 100 receives a request for data transmission to the second peripheral device 600, the electronic device 100 may collect the identification information and the device information of the second peripheral device 600. The electronic device 100 may provide, to the server device 200, specific data, such as the first data and the collected identification information and device information of the second peripheral device 600, and a data conversion request.

According to various embodiments, in the case where the server device 200 stores the device information of the second peripheral device 600 in advance, the electronic device 100 may provide the first data, the identification information of the second peripheral device 600 and the data conversion request to the server device 200. According to various embodiments, the electronic device 100 may provide the first data, the identification information of the second external device 400, the device information of the second peripheral device 600 and a second type conversion request to the server device 200. Here, the electronic device 100 may send, to the second peripheral device 400 directly or via the server device 200, a request for transferring the second type conversion data to the second peripheral device 600.

The server device 200 may generate the second type conversion data (data matched to the data processing type of the second peripheral device 600) on the basis of the first data in operation 1203. The server device 200 may transmit the second type conversion data to the second external device 400 in operation 1205.

The second external device 400 may transmit the received second type conversion data to the second peripheral device 600 in operation 1207. Here, the second peripheral device 600 may be connected to the second external device 400 through a direct communication channel or cable. The second external device 400 may receive, from the server device 200 or the electronic device 100, a message for requesting transmission of the second type conversion data to the second peripheral device 600. According to various embodiments, the second external device 400 may check the data processing type of the second type conversion data, and may transfer the second type conversion data to the second peripheral device 600 if the data processing type corresponds to the device information of the second peripheral device 600. The second peripheral device 600 may output or store the received second type conversion data.

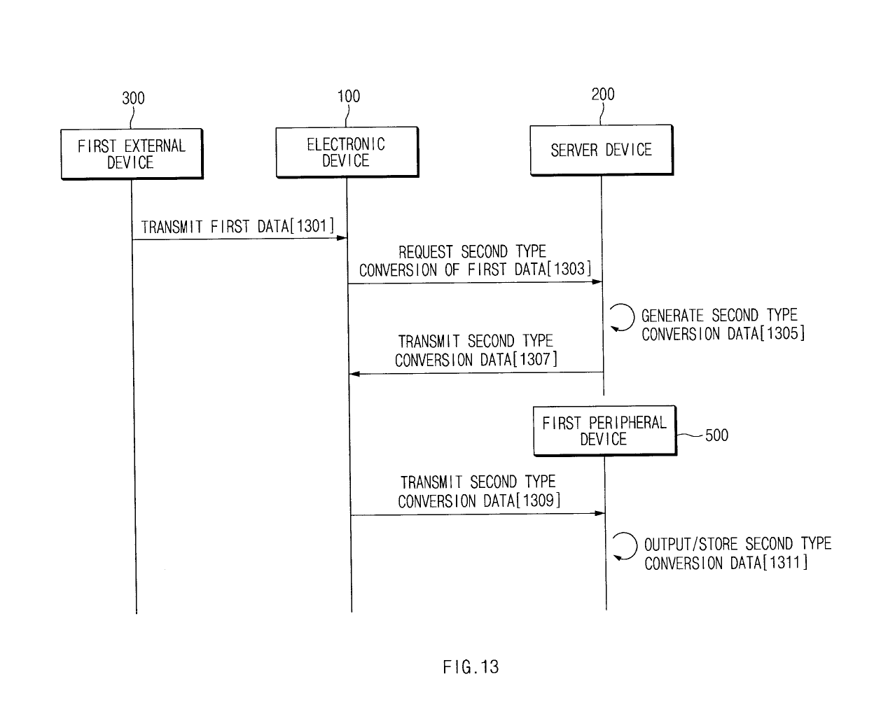

FIG. 13 is a diagram illustrating data conversion processing among an electronic device, a server device, a first external device and a first peripheral device according to an embodiment.

Referring to FIG. 13, the first external device 300 may request the electronic device 100 to transmit the first data to the first peripheral device 500, while transmitting the first data to the electronic device 100 in operation 1301. The electronic device 100 may determine whether the data processing type of the first data is able to be processed in the first peripheral device 500. In the case where the data processing type of the first data is unable to be processed in the first peripheral device 500, the electronic device 100 may request second type conversion (conversion of the first data into a data type matched to the data processing type of the first peripheral device 500), while transmitting the first data to the server device 200 in operation 1303. In this operation, the electronic device 100 may collect the device information of the first peripheral device 500 to provide the device information to the server device 200.

The server device 200 may generate the second type conversion data on the basis of the first data in operation 1305. The server device 200 may check the device information of the first peripheral device 500 received from the electronic device 100, and may generate the second type conversion data having the data processing type corresponding to the device information. The server device 200 may transmit the second type conversion data to the electronic device 100 in operation 1307.

The electronic device 100 may transmit the received second type conversion data to the first peripheral device 500 in operation 1309. The first peripheral device 500 may be connected to the electronic device 100 through a direct communication channel or by wire. Upon receiving the second type conversion data from the server device 200, the electronic device 100 may check the type of the second type conversion data. If the second type conversion data is matched to the data processing type of the first peripheral device 500, the electronic device 100 may transfer the second type conversion data to the first peripheral device 500. Alternatively, if the electronic device 100 receives, from the server device 200, the second type conversion data together with a message for requesting transmission of the second type conversion data to the first peripheral device 500, the electronic device 100 may transmit the second type conversion data to the first peripheral device 500.

The first peripheral device 500 may output and store the second type conversion data in operation 1311.

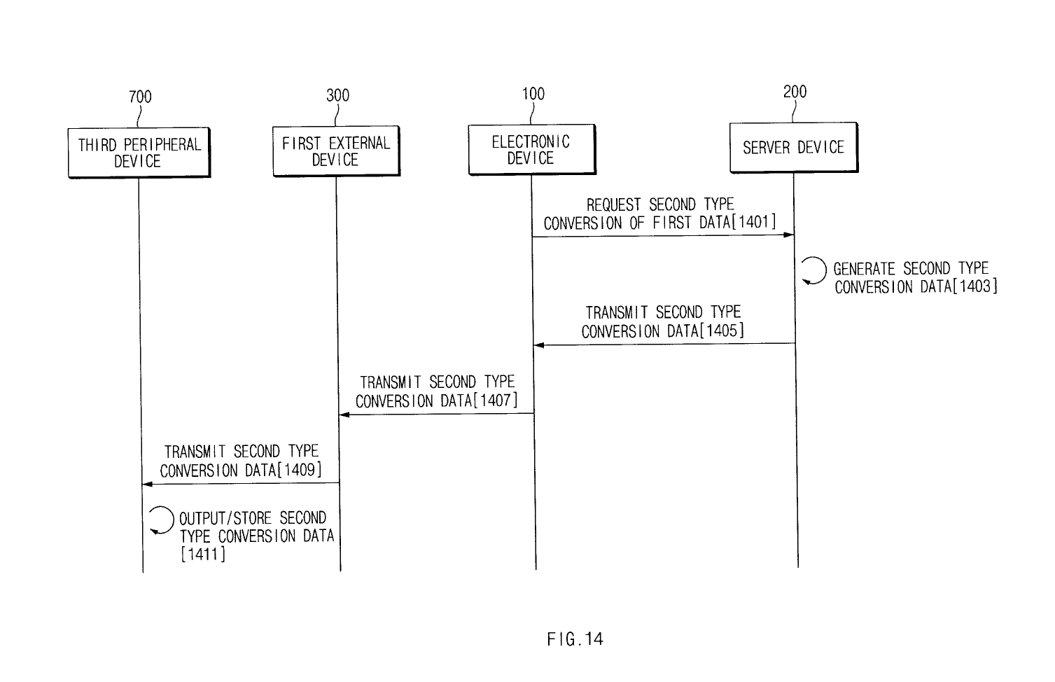

FIG. 14 is a diagram illustrating data conversion processing among an electronic device, a server device, a first external device and a third peripheral device according to an embodiment.

Referring to FIG. 14, the electronic device 100 may make a request for second type conversion, while transmitting the first data to the server device 200 in operation 1401. Here, the request for second type conversion may be a request for conversion to a data type matched to the data processing type of the third peripheral device 700. In relation to this operation, the electronic device 100 may collect connection state information of the first external device 300 and the third peripheral device 700. For example, the electronic device 100 may obtain the connection state information of the third peripheral device 700 from the first external device 300 connected to the electronic device 100 through a direct communication channel. The electronic device 100 may support a data transmission function on the basis of the connection state information of other electronic devices. For example, if a function related to transmission of specific data to another electronic device is performed, the electronic device 100 may collect and display information on other electronic devices to which data is able to be transmitted. If an item of the third peripheral device 700 is selected from among displayed items, the electronic device 100 may collect the identification information and the device information of the third peripheral device 700. Furthermore, the electronic device 100 may provide the collected information and transmission-requested data to the server device 200.

The server device 200 may generate the second type conversion data on the basis of the first data in operation 1403. For example, the server device 200 may generate the second type conversion data matched to the data processing type of the third peripheral device 700. The server device 200 may transmit the second type conversion data to the electronic device 100 in operation 1405. The electronic device 100 may transmit the received second type conversion data to the first external device 300 in operation 1407. The first external device 300 may transmit the received second-type conversion data to the third peripheral device 700. The third peripheral device 700 may output or store the received second type conversion data.

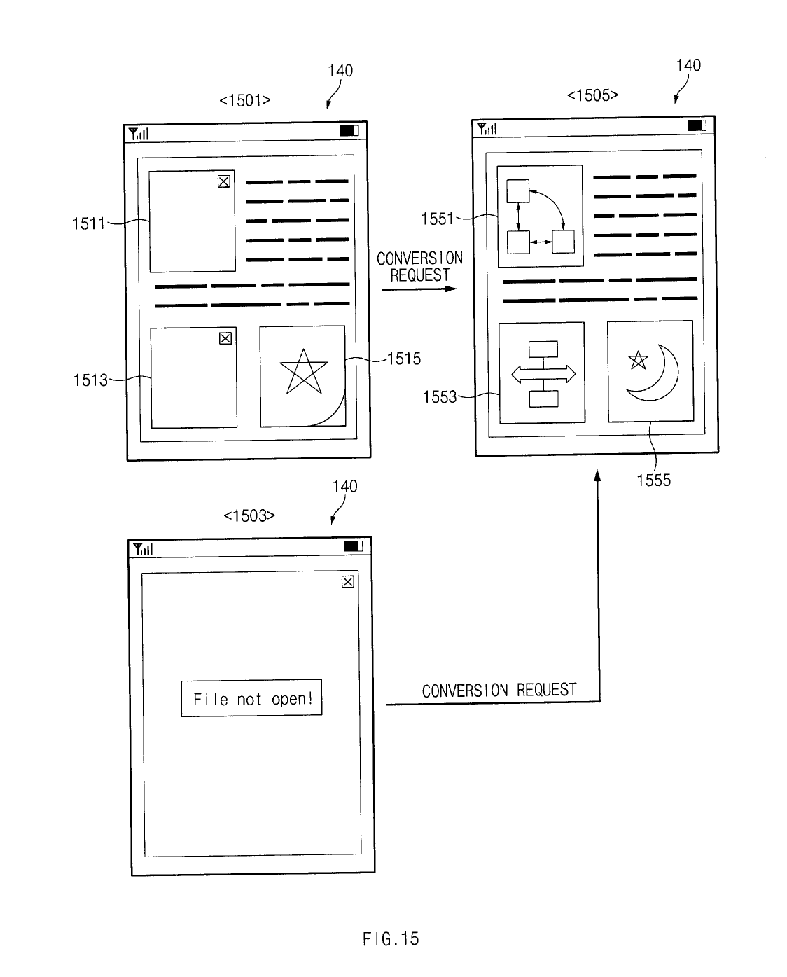

FIG. 15 is a diagram illustrating a screen interface of an electronic device related to data conversion processing according to an example embodiment.

Referring to FIG. 15, the control module 160 of the electronic device 100 may control display, playback or general output of specific data, including data that is may be incompatible or unsupported by the data processing functionality of the electronic device 100 in response to the occurrence of an event (such as a request to display a webpage). Accordingly, the display module 140 may output a screen including some objects included thereon show as errors, as illustrated in a screen 1501. For example, the display module 140 may display in the requested screen 1501 a first error object 1511 and a second error object 1513, representing objects that were incompatible, and thus not displayed or decoded normally. Furthermore, the display module 140 may output a third error object 1515, representing objects that are not optimized with hardware or software characteristics of the display module 140, and thus displayed incorrectly. In particular, the third error object 1515 illustrates a case in which an object is not optimized for a scale or resolution of the display module 140, and is thus displayed incorrectly as magnified, relative to the intended display.

According to other various embodiments, the control module 160 of the electronic device 100 may perform playback, display or output of specific data, including, for example, data not optimized or compatible with data processing functionality of the electronic device 100. The result is that the display module 140 simply displays the screen showing the error as illustrated in screen 1503. In such cases, the display module 140 may simply display a popup message indicating that the data is unable to be displayed, as seen in screen 1503.

In the states illustrated by the screens 1501 and 1503, the control module 160 may attempt to correctly display the objects 1511, 1513 and 1515 utilizing a conversion request. Relatedly, the control module 160 may also provide functionality allowing any of the objects 1511, 1513 and 1515 to be selected through a menu or user interface to facilitate a data conversion request for that particular object. Thus, according to various embodiments, when playback of the nonoptimized or unsupported data is requested, the control module 160 may output screen 1501 or 1503 by default, and then may automatically process a conversion request by transmitting, via control module 160, the specific data to the server device 200. Furthermore, the control module 160 may then receive, from the server device 200, the converted data now matching a first type of data compatible with and/or optimized for the data processing functionality of the electronic device 100.

The display module 140 may output the received converted data as illustrated in a screen 1505. The display module 140 may output, for example, the converted first object 1551 and a second object 1553, which are now displayed normally. Furthermore, the display module 140 may output a converted third object 1555, which is also now displayed normally. Thus, conversion to a compatible data type enables normal display of the objects on the electronic device, and said conversion may be executed via the external server device 200.

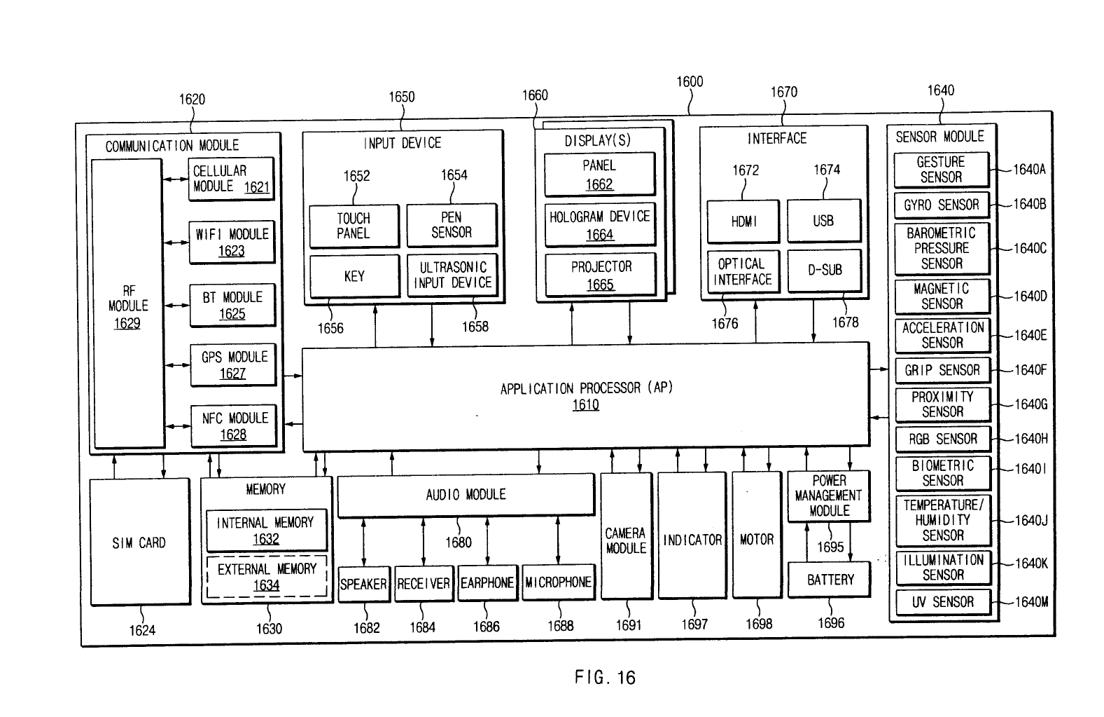

FIG. 16 is a block diagram illustrating an electronic device according to another embodiment.

Referring to FIG. 16, an electronic device 1600 may include, for example, a part or the entirety of the electronic device 100, the external device 300, the external device 400 or the peripheral devices 500 to 700 illustrated in FIG. 1.

Referring to FIG. 16, the electronic device 1600 may include at least one application processor (AP) 1610 (e.g., the control module 160 of FIG. 1, the server control module 260 of FIG. 3), a communication module 1620 (e.g., the communication interface 110 of FIG. 1), a subscriber identification module (SIM) card 1624, a memory 1630 (e.g., the storage module 150 of FIG. 1), a sensor module 1640, an input device 1650 (e.g., the input module 120 of FIG. 1), a display 1660 (e.g., the display module 140 of FIG. 1), an interface 1670, an audio module 1680 (e.g., the audio module 130 of FIG. 1), a camera module 1691, a power management module 1695, a battery 1696, an indicator 1697 and a motor 1698.

The AP 1610 may run an operating system or an application program so as to control a plurality of hardware or software elements connected to the AP 1610, and may process various data including multimedia data and may perform an operation thereon. The AP 1610 may be implemented with, for example, a system on chip (SoC). According to an embodiment, the AP 1610 may further include a graphic processing unit (GPU, not illustrated). According to an embodiment, various modules related to the above-mentioned data type conversion processing may be implemented in the AP 1610. The AP 1610 may control relevant modules to control data type conversion and processing of data not optimized for playback in the electronic device.

According to an embodiment, the various modules related to data type conversion and processing may be separately arranged in at least one of a communication processor (CP) and the AP. Here, module controlled by the CP may be arranged in the same chipset as that of the CP so as to allow direct communication therewith, or may be hardware-configured so as to be connected to the CP through an external interface.

According to an embodiment, the various modules related to data type conversion processing may be arranged in the CP. The CP may control relevant modules. In this case, the CP may be communicably connected to a cellular communication module and a WiFi module. Here, the elements may be connected to each other by a system bus in the same chipset so as to be communicable with each other even though the AP is in a power saving mode. In the case where the elements are configured with different chips, the elements may be connected to the external interface so as to be able to communicate with each other without the AP.

The communication module 1620 may perform data transmission/reception for communication between the electronic device 1600 (e.g., the electronic device 100) and the server device 200 connected thereto through a network. According to an embodiment, the communication module 1620 may include a cellular module 1621, a WiFi module 1623, a BT module 1625, a GPS module 1627, an NFC module 1628, and a radio frequency (RF) module 1629.

The cellular module 1621 may provide a voice call service, a video call service, a text message service, or an Internet service through a telecommunications network (e.g., LTE, LTE-A, CDMA, WCDMA, UMTS, WiBro or GSM network). Furthermore, the cellular module 1621 may identify and authenticate electronic devices in the telecommunications network using, for example, a subscriber identification module (e.g., the SIM card 1624). According to an embodiment, the cellular module 1621 may perform at least a part of functions provided by the AP 1610. For example, the cellular module 1621 may perform at least a part of a multimedia control function.

According to an embodiment, the cellular module 1621 may include a communication processor (CP). The cellular module 1621 may be implemented with, for example, an SoC. Although FIG. 16 illustrates that the cellular module 1621 (e.g., a communication processor), the memory 1630 and the power management module 1695 are separate from the AP 1610, the AP 1610 may include at least a part of the foregoing elements (e.g., the cellular module 1621), according to an embodiment.

According to an embodiment, the AP 1610 or the cellular module 1621 (e.g., a communication processor) may load, on a volatile memory, a command or data received from a nonvolatile memory connected to the AP 1610 or the cellular module 521 or at least one of other elements, so as to process the command or data. Furthermore, the AP 1610 or cellular module 1621 may store, in the nonvolatile memory, data received from or generated by at least one of the other elements.

According to various embodiments, the cellular module 1621 may be included in the communication interface 110 of FIG. 1. The cellular module 1621 may establish a communication channel to the server device 200 for an operation of the electronic device 100 for processing voice commands. Furthermore, the cellular module 1621 may transmit the first data at least a part of which is not matched to the data processing type of the electronic device to the server device 200, and may receive the first type conversion data matched to the data processing type of the electronic device 100 from the server device 200.

Each of the WiFi module 1623, the BT module 1625, the GPS module 1627 and the NFC module 1628 may include, for example, a processor for processing data transmitted/received through the modules. The WiFi module 1623 and the BT module 1625 may be included in at least one of the communication interface 110 and the sub communication module 230. The GPS module 1627 may be included in the communication interface 110.

FIG. 16 illustrates that the cellular module 1621, the WiFi module 1623, the BT module 1625, the GPS module 1627 and the NFC module 1628 are separate blocks. However, according to an embodiment, at least a part (e.g., two or more) of the cellular module 1621, the WiFi module 1623, the BT module 1625, the GPS module 1627 and the NFC module 1628 may be included in a single integrated chip (IC) or IC package. For example, at least a part (e.g., a communication processor corresponding to the cellular module 1621 and a WiFi processor corresponding to the WiFi module 1623) of the cellular module 1621, the WiFi module 1623, the BT module 1625, the GPS module 1627 and the NFC module 1628 may be implemented with a single SoC.

According to various embodiments, the WiFi module 1623 may be included in the communication interface 110 of FIG. 1. The WiFi module 1623 may establish a communication channel between the electronic device 100 and the server device 200 as described above. The WiFi module 1623 may transmit, to the server device 200, at least one of the first data, the identification information of the electronic device 100, the device information of the electronic device 100, the identification information or the device information of the external device 300 and the external device 400, and the identification information and the device information of the peripheral devices 500 to 600. The WiFi module 1623 may receive, from the server device 200, at least one of the first type conversion data matched to the data processing type of the electronic device, the second type conversion data matched to the data processing type of the external device, and the third type conversion data matched to the data processing type of the peripheral device.

The RF module 1629 may transmit/receive data, for example, may transmit/receive RF signals. Although not illustrated, for example, a transceiver, a power amp module (PAM), a frequency filter or a low noise amplifier (LNA) may be included in the RF module 1629. Furthermore, the RF module 1629 may further include a component such as a conductor or a wire for transmitting/receiving free-space electromagnetic waves in a wireless communication system. FIG. 16 illustrates that the cellular module 1621, the WiFi module 1623, the BT module 1625, the GPS module 1627 and the NFC module 1628 share the single RF module 1629. However, according to an embodiment, at least one of the cellular module 1621, the WiFi module 1623, the BT module 1625, the GPS module 1627 and the NFC module 1628 may transmit/receive RF signals through an additional RF module.

The SIM card 1624 may include a subscriber identification module, and may be inserted into a slot formed at a specific location of the electronic device. The SIM card 1624 may include unique identification information (e.g., an integrated circuit card identifier (ICCID)) or subscriber information (e.g., international mobile subscriber identity or IMSI). According to an embodiment, the SIM card 1624 may be an element of the memory device. When the SIM card 1624 is inserted into a slot, the AP 1610 may initialize the SIM card 1624.

The memory 1630 (e.g., the storage module 150) may include an internal memory 1632 or an external memory 1634. The internal memory 1632 may include at least one of a volatile memory (e.g., a dynamic RAM (DRAM), a static RAM (SRAM) or a synchronous dynamic RAM (SDRAM)) and a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory). According to an embodiment, the internal memory 1632 may be a solid state drive (SSD).

The external memory 1634 may include a flash drive, for example, compact flash (CF), secure digital (SD), micro secure digital (Micro-SD), mini secure digital (Mini-SD), extreme digital (xD) or a memory stick. The external memory 1634 may be functionally connected to the electronic device 1600 through various interfaces. According to an embodiment, the electronic device 1600 may further include a storage device (or a storage medium) such as a hard drive. The memory 1630 may store at least one of the first data at least a part of which is not matched to the data processing type of the electronic device, the first type conversion data obtained through conversion of the first data, and another type conversion data transferred to another electronic device. Furthermore, the memory 1630 may include the device information and the identification information of other electronic devices. Furthermore, the memory 1630 may store the data processing type information of the server device 200.

The sensor module 1640 may measure physical quantity or detect an operation state of the electronic device 1600 so as to convert measured or detected information into an electrical signal. The sensor module 1640 may include, for example, at least one of a gesture sensor 1640A, a gyro sensor 1640B, a barometric pressure sensor 1640C, a magnetic sensor 1640D, an acceleration sensor 1640E, a grip sensor 1640F, a proximity sensor 1640G, a color sensor 1640H (e.g., a red/green/blue (RGB) sensor), a biometric sensor 1640I, a temperature/humidity sensor 1640J, an illumination sensor 1640K, and an ultraviolet (UV) sensor 1640M. Additionally or alternatively, the sensor module 1640 may include, for example, an olfactory sensor (E-nose sensor, not illustrated), an electromyography (EMG) sensor (not illustrated), an electroencephalogram (EEG) sensor (not illustrated), an electrocardiogram (ECG) sensor (not illustrated), an infrared (IR) sensor (not illustrated), an iris recognition sensor (not illustrated), or a fingerprint sensor (not illustrated). The sensor module 1640 may further include a control circuit for controlling at least one sensor included therein.

The sensor module 1640 may collect a predefined motion sensor signal related to a request for type conversion of the first data and a predefined motion sensor signal related to output, storage or transfer of type converted data. The AP 1610 may control performance of predefined functions mapped to motion sensor signals, on the basis of the collected sensor signals.

The input device 1650 may include a touch panel 1652, a (digital) pen sensor 1654, a key 1656, or an ultrasonic input device 1658. The input device 1650 may include the input module 120 of FIG. 1.

The touch panel 1652 may recognize a touch input using at least one of capacitive, resistive, infrared and ultraviolet sensing methods. The touch panel 1652 may further include a control circuit. In the case of using the capacitive sensing method, a physical contact recognition or proximity recognition is allowed. The touch panel 1652 may further include a tactile layer. In this case, the touch panel 1652 may provide tactile reaction to a user.

According to an embodiment, the touch panel 1652 may generate a touch event related to data type conversion processing. For example, the touch panel 1652 may provide, in relation to a screen interface, a touch event indicating access to the server device 200, a touch event indicating a request for type conversion of the first data, a touch event for requesting a search for adjacent other electronic devices, and an event of selecting a specific other electronic device for transmitting data.

The (digital) pen sensor 1654 may be implemented in a similar or same manner as that for receiving a touch input of a user, or may be implemented using an additional sheet for recognition. The key 1656 may include, for example, a physical button, an optical button, or a keypad. At least one of the keys 1656, for example, a home key, may generate a key event related to activation of a voice search function or a key event related to activation of a voice command providing function. The ultrasonic input device 1658, which is an input device for generating an ultrasonic signal, may enable the electronic device 1600 to sense a sound wave through a microphone (e.g., a microphone 1688) so as to identify data, wherein the ultrasonic input device 1658 is capable of wireless recognition. According to an embodiment, the electronic device 1600 may use the communication module 1620 so as to receive a user input from an external device (e.g., a computer, a server device, or a peripheral device) connected to the communication module 1620.

The display 1660 (e.g., the display module 140) may include a panel 1662, a hologram device 1664, or a projector 1666. The panel 1662 may be, for example, a liquid crystal display (LCD) or an active-matrix organic light-emitting diode (AM-OLED). The panel 1662 may be, for example, flexible, transparent or wearable. The panel 1662 and the touch panel 1652 may be integrated into a single module. The hologram device 1664 may display a stereoscopic image in a space using a light interference phenomenon. The projector 1666 may project light onto a screen so as to display an image. The screen may be disposed in the inside or the outside of the electronic device 1600. According to an embodiment, the display 1660 may further include a control circuit for controlling the panel 1662, the hologram device 1664, or the projector 1666.

The interface 1670 may include, for example, a high definition multimedia interface (HDMI) 1672, a universal serial bus (USB) 1674, an optical interface 1676, or a D-subminiature (D-sub) 1678. Additionally or alternatively, the interface 1670 may include, for example, a mobile high-definition link (MHL) interface, a secure digital (SD) card/multi-media card (MMC) interface, or an infrared data association (IrDA) interface.

The audio module 1680 (e.g., the audio module 130 of FIG. 1) may convert a sound into an electrical signal or vice versa. The audio module 1680 may process sound information input or output through a speaker 1682, a receiver 1684, an earphone 1686, or the microphone 1688. According to an embodiment, the audio module 130 disposed in the electronic device 100 may collect audio data. Furthermore, the audio module 130 may output audio data related to data type conversion processing.

The camera module 1691 for shooting a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 1695 may manage power of the electronic device 1600. According to an embodiment, the power management module 1695 may control supply of power to at least one element of the electronic device 100. For example, the power management module 1695 may cut off power supply to specific device elements (e.g., the sensor module 1640, a communication module establishing a direct communication channel, a GPS module) if a battery power level of the electronic device 100 is equal to or lower than a set value. In response to disconnection from the server device 200, the power management module 1695 may change power supply to device elements enabled in relation to a communication function. Although not illustrated, a power management integrated circuit (PMIC), a charger integrated circuit (IC), or a battery or fuel gauge may be included in the power management module 1695.

The PMIC may be mounted on an integrated circuit or an SoC semiconductor. A charging method may be classified into a wired charging method and a wireless charging method. The charger IC may charge a battery, and may prevent an overvoltage or an overcurrent from being introduced from a charger. According to an embodiment, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier.

The battery gauge may measure, for example, a remaining capacity of the battery 1696 and a voltage, current or temperature thereof while the battery is charged. The battery 1696 may store or generate electricity, and may supply power to the electronic device 1600 using the stored or generated electricity. The battery 1696 may include, for example, a rechargeable battery or a solar battery.

The indicator 1697 may display a specific state of the electronic device 1600 or a part thereof (e.g., the AP 1610), such as a booting state, a message state, or a charging state. The motor 1698 may convert an electrical signal into a mechanical vibration. Although not illustrated, a processing device (e.g., a GPU) for supporting a mobile TV may be included in the electronic device 1600. The processing device for supporting a mobile TV may process media data according to the standards of digital multimedia broadcasting (DMB), digital video broadcasting (DVB) or media flow.

Each of the above-mentioned elements of the electronic device according to the present disclosure may be configured with one or more components, and the names of the elements may be changed according to the type of the electronic device. The electronic device according to the present disclosure may include at least one of the above-mentioned elements, and some elements may be omitted or other additional elements may be added. Furthermore, some of the elements of the electronic device according to the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according to the present disclosure may include at least one of an application-specific integrated circuit (ASIC) chip, a field-programmable gate array (FPGA), and a programmable-logic device for performing some operations, which are known or will be developed.

According to the various embodiments, at least a part of devices (e.g., modules or functions thereof) or methods (e.g., operations) according to the present disclosure may be implemented as instructions stored in a computer-readable storage medium in the form of a programming module. In the case where the instructions are performed by at least one processor (e.g., the controller 160), the at least one processor may perform functions corresponding to the instructions. The computer-readable storage medium may be, for example, the memory. At least a part of the programming module may be implemented (e.g., executed) by the processor. At least a part of the programming module may include, for example, a module, program, routine, sets of instructions, or process for performing at least one function.

The computer-readable storage medium may include a magnetic medium such as a hard disk, a floppy disk and a magnetic tape, an optical medium such as a compact disk read only memory (CD-ROM) and a digital versatile disc (DVD), a magneto-optical medium such as a floptical disk, and a hardware device configured to store and execute program instructions (e.g., programming module), such as a read only memory (ROM), a random access memory (RAM) and a flash memory. The program instructions may include machine language codes made by compilers and high-level language codes that can be executed by computers using interpreters. The above-mentioned hardware may be configured to be operated as one or more software modules for performing operations of the present disclosure and vice versa.

The module or programming module according to the present disclosure may include at least one of the above-mentioned elements, or some elements may be omitted or other additional elements may be added. Operations performed by the module, the programming module or the other elements may be performed in a sequential, parallel, iterative or heuristic way. Furthermore, some operations may be performed in another order or may be omitted, or other operations may be added.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, numbers, steps, operations, elements, components, or combinations thereof but does not preclude the presence or addition of one or more other features, numbers, steps, operations, elements, components, or combinations thereof.

The meaning of the term “or” used herein includes any combination of words connected by the term “or”. For example, the expression “A or B” may indicate A, B, or both A and B.

The terms such as “first”, “second”, and the like used herein may refer to various elements of various embodiments, but do not limit the elements. For example, such terms do not limit the order and/or priority of the elements. Furthermore, such terms may be used to distinguish one element from another element. For example, without departing the scope of the various embodiments, a first element may be referred to as a second element and vice versa.

It will be understood that when an element is referred to as being “linked”, “connected” or “coupled” to another element, it can be directly connected or coupled to the other element or intervening elements may be present. In contrast, when an element is referred to as being “directly connected” or “directly coupled” to another element, it should be understood that there are no intervening elements.

The terminology used herein is not for delimiting the various embodiments but for describing specific embodiments. The terms of a singular form may include plural forms unless otherwise specified.

The terms used herein, including technical or scientific terms, have the same meanings as understood by those skilled in the art unless otherwise defined herein. The commonly used terms such as those defined in a dictionary should be interpreted in the same context as in the related art and should not be interpreted in an idealized or overly formal sense unless otherwise defined explicitly.

An electronic device according to various embodiments may include at least one of a smartphone, a tablet personal computer (PC), a mobile phone, a video telephone, an electronic book reader, a desktop PC, a laptop PC, a netbook computer, a personal digital assistant (PDA), a portable multimedia player (PMP), an MP3 player, a mobile medical device, a camera or a wearable device (e.g., a head-mounted-device (HMD) such as electronic glasses, electronic apparel, an electronic bracelet, an electronic necklace, an electronic appcessory, an electronic tattoo or a smartwatch).

According to some embodiments, the electronic device may be a smart home appliance. The smart home appliance may include at least one of, for example, a TV, a DVD player, an audio, a refrigerator, an air conditioner, a cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to some embodiments, the electronic device may include at least one of a medical device (e.g., magnetic resonance angiography or MRA, magnetic resonance imaging or MRI, computed tomography or CT, a scanner or an ultrasonic device), a navigation device, a global positioning system (GPS) receiver, an event data recorder (EDR), a flight data recorders (FDR), a vehicle infotainment device, electronic equipment for ship (e.g., a navigation system or a gyrocompass), avionics, a security device, a head unit for a vehicle, an industrial or home robot, an automatic teller's machine (ATM), or a point of sales (POS).

According to some embodiments, the electronic device may include at least one of a part of furniture or a building/structure, an electronic board, an electronic signature receiving device, a projector, or measuring instruments (e.g., water meters, electricity meters, gas meters, or wave meters). The electronic device according to various embodiments may be one or more combinations of the above-mentioned devices. Furthermore, the electronic device according to the present disclosure may be a flexible device. It would be obvious to those skilled in the art that the electronic devices according to various embodiments are not limited to the above-mentioned devices.

As described above, according to the data conversion processing method and the electronic device supporting the same according to various embodiments, data that is not output normally through the electronic device, for example, data that causes an error when being output, data unable to be adjusted in scale, or data of which content arrangement is not optimized for the display module of the electronic device, is converted into a data format compatible with the electronic device so that an information recognition rate may be improved and information may be more easily shared.

Furthermore, according to various embodiments, access control of an external electronic device connectable to the electronic device by at least one hop and access control of a peripheral device may be more easily performed. Therefore, according to various embodiments, a user may output or store optimized data through at least one device at a desired place and a desired time.

The above embodiments of the present disclosure are illustrative and not limitative. Various alternatives and equivalents are possible. Other additions, subtractions, or modifications are obvious in view of the present disclosure and are intended to fall within the scope of the appended claims.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” constitutes hardware in the claimed invention. Under the broadest reasonable interpretation, the appended claims constitute statutory subject matter in compliance with 35 U.S.C. §101.

What is claimed is:

1. An electronic device comprising:
a communication interface configured to communicate with an external server; and
a control module configured to:
receive a request to display content that is at least one of unoptimized or incompatible with data processing functionality of the electronic device,
in response to the request, transmit to the external server the content and at least one of a desired format and a configuration setting of the electronic device,
receive from the external server a converted content optimized or compatible with the data processing functionality, converted by a renderer of the external server utilizing the at least one of the desired format and the configuration setting, and
display the converted content on the display.

2. The electronic device according to claim 1, the control module further configured to calculate a source rendering representation rate indicating a proximity between a render of the content to a source of the content, wherein the source rendering representation rate of the content rendered by a renderer of the external server is less than the source rendering representation rate of the content rendered by a renderer of the electronic device.

3. The electronic device according to claim 2, the content is unoptimized with data processing functionality of a first renderer of the electronic device rendering at a first quality level, and the renderer of the external server renders the content at a second quality level, wherein the second quality level is equal or similar to a quality level of a renderer operated by a general purpose OS.

4. The electronic device according to claim 3, wherein the general purpose OS is at least one of Windows OS and MAC OS.

5. The electronic device according to claim 1, wherein the content is of a first format, and the converted content is of a second format, and the first format is unoptimized or incompatible with the data processing functionality, and the second format is optimized or compatible with the data processing functionality.

6. The electronic device according to claim 1, wherein the converted content comprises a sub-function executable by the electronic device.

7. The electronic device according to claim 6, wherein the sub-function comprises at least one of rewind, fast-forward, playback, pause, rotation and a go-to-page function.

8. The electronic device according to claim 6, wherein the control module further executes a program for displaying a user interface for the sub function and commanding performance of the sub-function.

9. The electronic device according to claim 1, wherein the control module is further configured to:
receive a second request to transmit the content to a peripheral device for display; and
in response to the second request, transmit to the server device information on the peripheral device relevant to converting the content to a data type suitable for the peripheral device.

10. The electronic device according to claim 9, wherein the information further comprises a driver related to hardware support or platform support of the peripheral device.

11. The electronic device according to claim 10, wherein the driver corresponds to the renderer of a second quality level of the external server.

12. The electronic device according to claim 11, wherein in response to the second request, the electronic device transmits the received converted content without converting the received converted content using the driver.

13. A method for operating an electronic device, the method comprising:
receiving a request to display content of a first format that is at least one of unoptimized and incompatible with data processing functionality of the electronic device,
in response to the request, transmitting to an external server the content and at least one of a desired second format and a configuration setting of the electronic device,
receiving from the external server a converted content optimized or compatible with the data processing functionality, converted by a renderer of the external server utilizing the at least one of the desired second format and the configuration setting, and
displaying the converted content on the display.

14. The method according to claim 13, wherein the first format comprises a web document format, and the second format comprises at least one of a PDF format, a PDL format, a HTML format, a XPS format, an image format and an applet format.

15. The method according to claim 13, wherein the content comprises at least one of an image, a picture, a captured scene of a video, and an advertisement.

16. The method according to claim 13, further comprising displaying at least a part of the content in the first format on a display before transmitting the content in the first format to the external server.

17. The method according to claim 16, wherein the content is transmitted in the first format to external server in response to detection of an input.

18. The method according to claim 13, wherein the content is automatically transmitted in the first format to the external server in response to the request.

19. The method according to claim 18, wherein the content in the first format is undisplayable on the electronic device because of the content being at least one of unoptimized and incompatible.

20. An electronic device, comprising:
a communication interface to communicate with an external server; and
a processor configured to;
receive a request to display content of a first format that is at least one of unoptimized and incompatible with data processing functionality of the electronic device,
in response to the request, transmit to the external server the content and at least one of a desired second format and a configuration setting of the electronic device,
receive from the external server a converted content optimized or compatible with the data processing functionality, converted by a renderer of the external server utilizing the at least one of the desired second format and the configuration setting, and
display the converted content on the display.
